(19) United States
(12) Patent Application Publication
(10) Pub. No.: US 2015/0195356 A1
(43) Pub. Date: Jul. 9, 2015

(54) METHOD OF PROVIDING INFORMATION BY ELECTRONIC DEVICE AND ELECTRONIC DEVICE

(71) Applicant: Samsung Electronics Co., Ltd., Suwon-si (KR)

(72) Inventors: Byung-Woan KIM, Yongin-si (KR); Kyung-Eun PARK, Suwon-si (KR); Ji-Hye SON, Suwon-si (KR); Seung-Taek OH, Seoul (KR); Kyung-Sub MIN, Seongnam-si (KR); Se-Jun SONG, Seoul (KR); Soon-Hyun CHA, Seoul (KR); Bo-Kun CHOI, Seoul (KR); Min-Kyung HWANG, Seoul (KR)

(21) Appl. No.: 14/590,692

(22) Filed: Jan. 6, 2015

Related U.S. Application Data
(60) Provisional application No. 61/924,451, filed on Jan. 7, 2014.

(30) Foreign Application Priority Data
Feb. 20, 2014 (KR) 10-2014-0019560

(51) Int. Cl. H04L 29/08

(52) U.S. Cl. CPC H04L 67/1095

(57) ABSTRACT

A method of providing information by an electronic device is provided. The method includes receiving a plurality of contents including first contents and second contents from at least one second application, by a first application executed in the electronic device, and generating third contents, which are different from at least some of the first contents or the second contents based on the first contents or the second contents, by the first application.

### CROSS-REFERENCE TO RELATED APPLICATION(S)

This application claims the benefit under 35 U.S.C. §119(e) of a U.S. provisional patent application filed on Jan. 7, 2014 in the U.S. Patent and Trademark Office and assigned Ser. No. 61/924,451, and under 35 U.S.C. §119(a) of a Korean patent application filed on Feb. 20, 2014 and assigned Serial number 10-2014-0019560, the entire disclosure of each of which is hereby incorporated by reference.

### TECHNICAL FIELD

The present disclosure relates to a method of providing information by an electronic device and an electronic device thereof. More particularly, the present disclosure relates to an information providing method by an electronic device capable of providing information through various methods, and an electronic device thereof.

### BACKGROUND

As mobile devices continue to be commonly used, there has been an increase in mobile device user activity and information sought by users. Based on the usability, a technology for transmitting proper information that users need at proper timing is required. Furthermore, as various wearable devices have been developed, various communion methods between the wearable devices communicating with mobile devices of the related art and users have also been developed.

A notification message for providing information to a current mobile device has an issue in a time point of information transmission and a form of information. First, in the case of the time point of the information transmission, since an application directly transmits information to a user unilaterally, the user may receive the message when the user does not want to receive it.

Moreover, in the form of the information, the substance of the notification message may be generally configured by text or provides simple information such as Badge, Banner, Pop-up, Indicator icon, Notification Center, Notification Drawer and the like. Accordingly, the user may have difficulty in effectively acquiring information on an application related to the message.

Therefore, a need exists for an information providing method by an electronic device that can provide information to a user through various schemes and an electronic device thereof.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an information providing method by an electronic device that can provide information to a user through various schemes and an electronic device thereof.

In accordance with an aspect of the present disclosure, a method of providing information by an electronic device is provided. The method includes receiving, by a first application executed in the electronic device, a plurality of contents including first contents and second contents from at least one second application, and generating third contents, which are different from at least some of one of the first contents and the second contents based on at least one of the first contents and the second contents, by the first application.

In accordance with another aspect of the present disclosure, a method of providing information by an electronic device is provided. The method includes receiving contents from a second application by using a first application executed in an electronic device, when at least one of a state of the electronic device and an attribute of the first application corresponds to at least one of a first state and a first attribute, providing at least some of the contents with a first format through an output device functionally connected to the electronic device, and when at least one of a state of the electronic device and an attribute of the first application corresponds to at least one of a second state and a second attribute, providing at least some of the contents with a second format through the output device.

In accordance with another aspect of the present disclosure, an electronic device is provided. The electronic device includes a first application configured to receive a plurality of contents including first contents and second contents from at least one second application and to generate third contents that are different from at least some of one of the first contents and the second contents based on the at least one of the first contents and the second contents.

In accordance with another aspect of the present disclosure, an electronic device is provided. The electronic device includes a first application configured to receive contents from a second application, to provide at least some of the contents with a first format through an output device functionally connected to the electronic device when at least one of a state of the electronic device and an attribute of the first application corresponds to at least one of a first state and a first attribute, and to provide the at least some of the contents with a second format through the output device when the state of the at least one of the electronic device and the attribute of the first application corresponds to at least one of a second state and a second attribute.

A method of providing information by an electronic device and an electronic device thereof, according to various embodiments of the present disclosure, may provide information to users through various methods.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to various embodiments of the present disclosure;

FIGS. 2A, 2B, and 2C illustrate a configuration of an information processor of an electronic device according to various embodiments of the present disclosure;

FIG. 3 illustrates contents according to various embodiments of the present disclosure;

FIG. 4 illustrates a configuration of contents including a plurality of pieces of function information according to various embodiments of the present disclosure;

FIG. 5 illustrates a configuration of a first application of an electronic device according to various embodiments of the present disclosure;

FIG. 6 illustrates an operation in which a first application registers a third application according to various embodiments of the present disclosure;

FIGS. 7, 8A, and 8B illustrate a plurality of content types registered in a second application or subscribed to by the second application according to various embodiments of the present disclosure;

FIG. 9 illustrates an operation in which a first application registers a second application according to various embodiments of the present disclosure;

FIG. 10 illustrates an operation in which a first application transmits contents of a second application according to various embodiments of the present disclosure;

FIG. 11 illustrates an operation in which a first application generates contents and provides the generated contents to a third application according to various embodiments of the present disclosure;

FIG. 12 illustrates a third application installed in an electronic device according to various embodiments of the present disclosure;

FIG. 13 illustrates a plurality of content types provided by one second application according to various embodiments of the present disclosure;

FIG. 14 illustrates one content type provided by a plurality of second applications according to various embodiments of the present disclosure;

FIG. 15 is a flowchart illustrating an operation in which a third application provides contents according to various embodiments of the present disclosure;

FIG. 16 is a flowchart illustrating an operation in which an electronic device displays contents based on a display according to various embodiments of the present disclosure;

FIGS. 17A and 17B illustrate an operation in which an electronic device displays contents based on a display according to various embodiments of the present disclosure;

FIG. 18 is a flowchart illustrating an operation in which an electronic device displays contents based on a display bending state of the electronic device according to various embodiments of the present disclosure;

FIGS. 19A and 19B illustrate an operation in which an electronic device displays contents based on a display bending state of the electronic device according to various embodiments of the present disclosure;

FIG. 20 is a flowchart illustrating an operation in which an electronic device displays contents based on a display folding state of the electronic device according to various embodiments of the present disclosure;

FIGS. 21A, 21B, and 21C illustrate an operation in which an electronic device displays contents based on a display folding state of the electronic device according to various embodiments of the present disclosure;

FIG. 22 is a flowchart illustrating an operation in which an electronic device displays contents based on a grip state of the electronic device according to various embodiments of the present disclosure;

FIGS. 23A and 23B illustrate an operation in which an electronic device displays contents based on a grip state of the electronic device according to various embodiments of the present disclosure;

FIG. 24 is a flowchart illustrating an operation in which an electronic device displays same contents according to various embodiments of the present disclosure;

FIGS. 25A and 25B illustrate an operation in which an electronic device displays same contents according to various embodiments of the present disclosure;

FIG. 26 is a flowchart illustrating an operation in which an electronic device outputs contents through a voice according to various embodiments of the present disclosure;

FIGS. 27A, 27B, and 28 illustrate an operation in which an electronic device outputs contents through a voice according to various embodiments of the present disclosure;

FIG. 29 is a flowchart illustrating an operation in which an electronic device outputs contents through a voice based on a position of the electronic device according to various embodiments of the present disclosure;

FIG. 30 illustrates an operation in which an electronic device outputs contents through a voice based on a position of the electronic device according to various embodiments of the present disclosure;

FIG. 31 is a flowchart illustrating an operation in which an electronic device displays contents based on a lock state of the electronic device according to various embodiments of the present disclosure;

FIGS. 32A, 32B, and 32C illustrate an operation in which an electronic device displays contents based on a lock state of the electronic device according to various embodiments of the present disclosure;

FIG. 33 is a flowchart illustrating an operation in which an electronic device executes function information of contents according to various embodiments of the present disclosure;

FIGS. 34A, 34B, and 34C illustrate an operation in which an electronic device executes function information of contents according to various embodiments of the present disclosure;

FIG. 35 is a flowchart illustrating an operation in which an electronic device changes function information of contents according to various embodiments of the present disclosure;

FIG. 36 is a flowchart illustrating an operation of performing function information of contents of an electronic device in another electronic device according to various embodiments of the present disclosure; and

FIG. 37 is a flowchart illustrating an operation in which an electronic device changes function information of contents based on a substance of the contents according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The term and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

In the present disclosure, the terms are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a device with a communication function. For example, the electronic device may include at least one of a smart phone, a tablet personal computer (PCs), a mobile phone, a video phone, an e-book reader, a desktop PC, a laptop PC, a netbook computer, a personal digital assistant (PDA), a portable multimedia player (PMP), a Motion Pictures Expert Group (MPEG-1 or MPEG-2) Audio Layer 3 (MP3) player, a mobile medical device, a camera, a wearable device (e.g., a head-mounted device (HMD), such as electronic glasses, electronic clothes, an electronic bracelet, an electronic necklace, an electronic accessory, an electronic tattoo, a smart watch, and the like).

According to some embodiments, the electronic device may be a smart home appliance with a communication function. The smart home appliance may include at least one of, for example, a television, a digital video disk (DVD) player, an audio player, a refrigerator, an air conditioner, a cleaner, an oven, a microwave oven, a washing machine, an air purifier, a set-top box, a TV box (e.g., HomeSync™ of Samsung, Apple TV™, or Google TV™), a game console, an electronic dictionary, an electronic key, a camcorder, or an electronic frame.

According to some embodiments, the electronic device may include at least one of various medical devices, such as a magnetic resonance angiography (MRA) scanner, a magnetic resonance imaging (MRI) scanner, a computed tomography (CT) scanner, a scanner, an ultrasonograph, or the like, a navigation device, a Global Positioning System (GPS) receiver, an Event Data Recorder (EDR), a Flight Data Recorder (FDR), a vehicle infotainment device, an electronic equipment for ship (for example a ship navigation device and gyro-compass and the like, avionics, a security device, a head unit for vehicle, an industrial or household robot, ATM (automatic teller machine) in banking facilities or POS (point of sales) in stores.

According to some embodiments, the electronic device may include at least one of furniture or a part of a building/structure having a communication function, an electronic board, an electronic signature receiving device, a projector, or various measuring equipment (e.g., an equipment for a water supply, an electricity, gases or radio waves). An electronic device according to various embodiments of the present disclosure may be a combination of one or more of above described various devices. In addition, an electronic device according to various embodiments of the present disclosure may be a flexible device. In addition, an electronic device according to various embodiments of the present disclosure is not limited to the above described devices.

Hereinafter, an electronic device according to various embodiments of the present disclosure will be described with reference to the accompanying drawings. In various embodiments, the term “user” may indicate a person using an electronic device or a device (e.g., an artificial intelligence electronic device) using an electronic device.

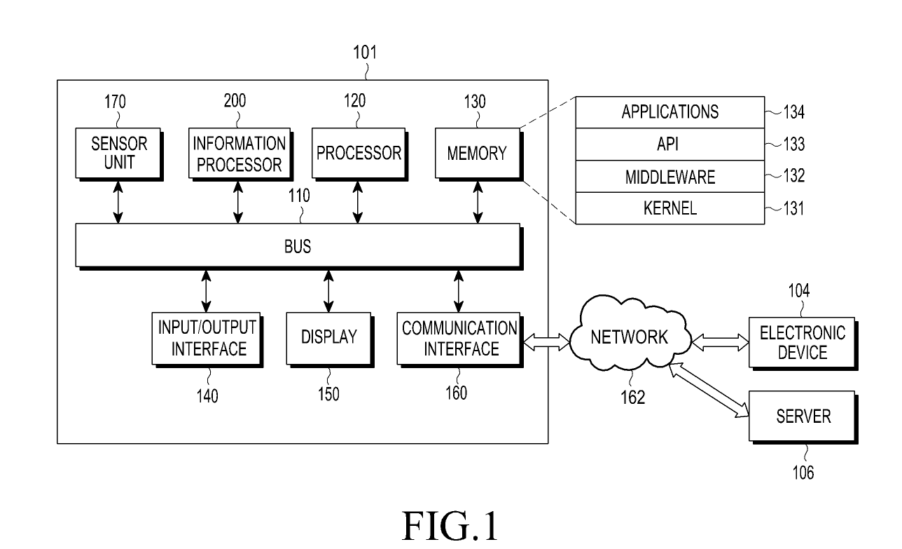

FIG. 1 is a block diagram of an electronic device according to various embodiments of the present disclosure.

Referring to FIG. 1, an electronic device 101 may include a bus 110, a processor 120, a memory 130, an input/output interface 140, a display 150, a communication interface 160, a sensor unit 170, and an information processor 200.

The bus 110 may be a circuit connecting the aforementioned elements and transmitting communication (for example, a control message) between the aforementioned elements.

The processor 120 may, for example, receive commands from other elements (for example, the memory 130, the input/output interface 140, the display 150, and the communication interface 160) through the bus 110, analyze the received commands, and execute calculation or data processing according to the analyzed commands.

The memory 130 may store commands or data that may be received from the processor 120 or other elements (for example, the input/output interface 140, the display 150, and the communication interface 160) or created by the processor 120 or other elements. The memory 130 may include programming modules, such as a kernel 131, middleware 132, an Application Programming Interface (API) 133 or applications 134. Each of the programming modules described above may be formed of software, firmware, and hardware, or a combination of two or more thereof.

The kernel 131 may control or manage system resources (for example, the bus 110, the processor 120, or the memory 130) used to execute operations or functions implemented by other programming modules, for example, the middleware 132, the API 133, or the applications 134. Furthermore, the kernel 131 may provide an interface capable of accessing and controlling or managing the individual elements of the electronic device 101 by using the middleware 132, the API 133, or the applications 134.

The middleware 132 may serve as a relay so that the API 133 or the applications 134 may communicate with the kernel 131 to exchange data. Furthermore, in regard to task requests received from the applications 134, the middleware 132 may perform a control (for example, scheduling or load balancing) for the task requests using, for example, a method of assigning a priority for using the system resources (for example, the bus 110, the processor 120, and the memory 130) of the electronic device 101 to at least one of the applications 134.

The API 133 is an interface through which the applications 134 may control functions provided by the kernel 131 and the middleware 132, and may include at least one interface or function (for example, instruction) for file control, window control, image processing, or text control.

According to various embodiments, the applications 134 may include a Short Message Service (SMS)/Multimedia Messaging Service (MMS) application, an email application, a calendar application, an alarm application, a health care application (for example, application measuring a quantity of exercise or blood sugar) or an application (for example, an application providing information on pressure, humidity or temperature information). Additionally or alternately, the applications 134 may include an application related to information exchange between the electronic device 101 and an external electronic device (for example, an electronic device 104). The application related to the information exchange may include, for example, a notification relay application for transferring particular information to the external electronic device or a device management application for managing the external electronic device.

For example, the notification relay application may include a function of transmitting notification information generated by another application (for example, an SMS/MMS application, an email application, a health care application, an environment information application, and the like) of the electronic device 101 to the external electronic device (for example, the electronic device 104). Additionally or alternatively, the notification relay application may receive the notification information from, for example, the external electronic device (for example, the electronic device 104), and may provide the received notification information to a user. The device management application may manage (for example, install, delete, or update), for example, a function for at least a part of the external electronic device (for example, the electronic device 104) communicating with the electronic device 101 (for example, turning on/off the external electronic device itself (or some elements thereof) or adjusting brightness (or resolution) of a display), applications operating in the external electronic device, or services provided from the external electronic device (for example, a telephone call service or a message service).

According to various embodiments, the applications 134 may include an application set based on an attribute (for example, the type of electronic device) of the external electronic device (for example, the electronic device 104). For example, in a case where the external electronic device is an MP3 player, the applications 134 may include an application related to the reproduction of music. Similarly, when the external electronic device is a mobile medical device, the applications 134 may include an application related to the health care. According to an embodiment, the applications 134 may include at least one of the applications designated to the electronic device 101 and an application received from the external electronic device (for example, a server 106 or the electronic device 104).

The input/output interface 140 may transfer a command or data input by a user through an input/output device (for example, a sensor, a keyboard, or a touch screen) to the processor 120, the memory 130, and the communication interface 160 through, for example, the bus 110. For example, the input/output interface 140 may provide the processor 120 with data for a user's touch input through the touch screen. Furthermore, the input/output interface 140 may output a command or data received from the processor 120, the memory 130, and the communication interface 160 through, for example, the bus 110, to an input/output device (for example, a speaker or a display). For example, the input/output interface 140 may output voice data processed through the processor 120 to a user through a speaker.

The display 150 may display various pieces of information (for example, multimedia data or text data) to a user.

The communication interface 160 may connect communication between the electronic device 101 and the external electronic device (for example, the electronic device 104 or the server 106). For example, the communication interface 160 may be connected to a network 162 through wireless or wired communication to communicate with the external device. The wireless communication may include at least one of the, for example, Wi-Fi, Bluetooth (BT), Near Field Communication (NFC), Global Positioning System (GPS) and cellular communication (for example, Long Term Evolution (LTE), LTE-A, Code Division Multiple Access (CDMA), Wideband CDMA (WCDMA), Universal Mobile Telecommunication System (UMTS), Wireless Broadband (WiBro), Global System for Mobile communication (GSM), and the like). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network 162 may be a telecommunication network. The communication network may include at least one of a computer network, the Internet, the Internet of things, and a telephone network. According to an embodiment, a protocol (for example, a transport layer protocol, data link layer protocol, or a physical layer protocol) for communication between the electronic device 101 and the external device may be supported by at least one of the applications 134, the application programming interface 133, the middleware 132, the kernel 131, and the communication interface 160.

The sensor unit 170 may measure a physical quantity or detect an operation state of the electronic device 101, and may convert the measured or detected information to an electrical signal. The sensor unit 170 may include at least one, for example, a gesture sensor, a gyro sensor, an atmospheric pressure sensor, a magnetic sensor, an acceleration sensor, a grip sensor, a proximity sensor, a color sensor (for example, a Red, Greed, and Blue (RGB) sensor), a bio sensor, a temperature/humidity sensor, an illumination sensor, and ultra violet (UV) sensor. Additionally or alternatively, the sensor unit 170 may include an E-nose sensor, an electromyography (EMG) sensor, an electroencephalogram (EEG) sensor, an electrocardiogram (ECG) sensor, an infrared (IR) sensor, an iris sensor, a fingerprint sensor and the like. The sensor unit 170 may further include a control circuit for controlling one or more sensors included in the sensor unit 170.

According to various embodiments, the information processor 200 may perform at least one of an operation for generating a plurality of contents by which information to be provided to a user can be configured, an operation for generating new contents based on the plurality of contents, and an operation for providing the new contents to the user.

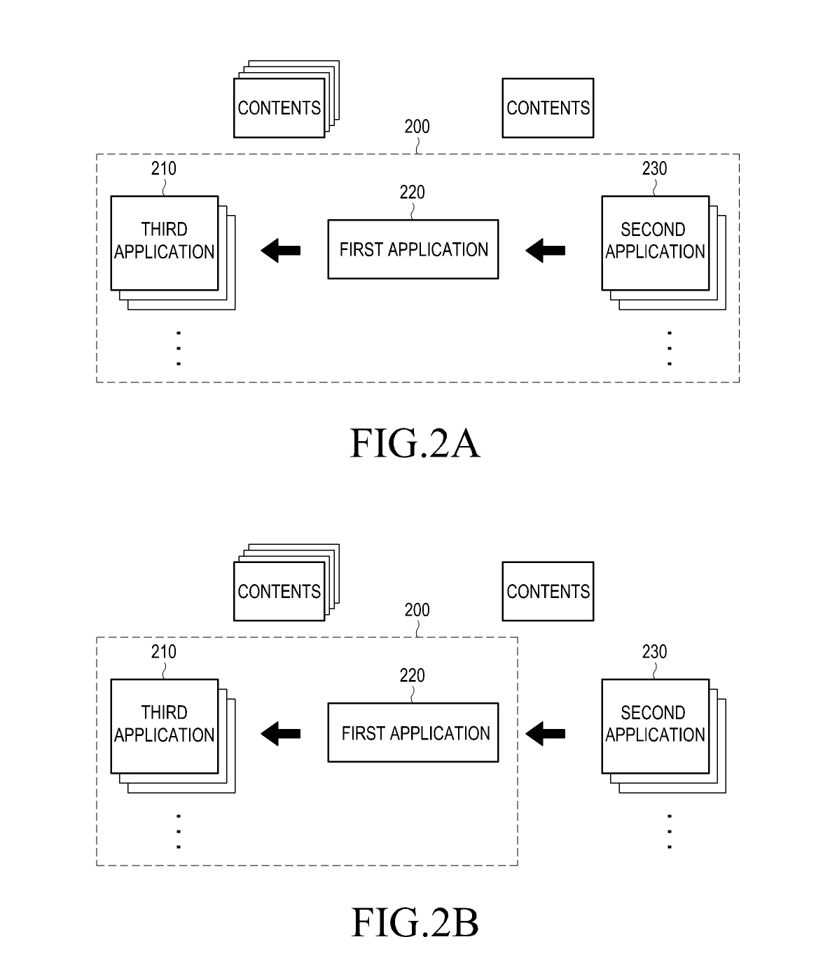

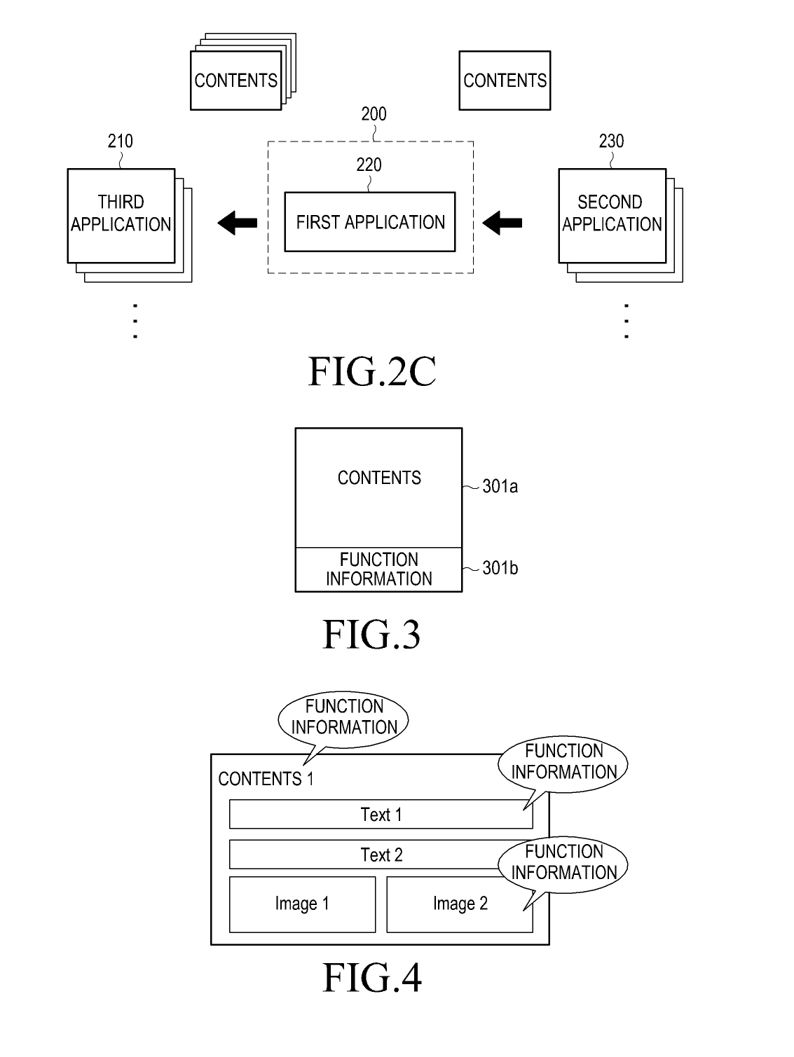

The configuration of the information processor 200 may be described below in FIGS. 2A, 2B, and, 2C.

FIGS. 2A, 2B, and 2C illustrate a configuration of an information processor of an electronic device according to various embodiments of the present disclosure.

Referring to FIG. 2A, the information processor 200 according to various embodiments of the present disclosure may include a third application 210, a first application 220, and a second application 230.

Referring to FIG. 2B, the information processor 200 according to various embodiments of the present disclosure may include the third application 210 and the first application 220.

Referring to FIG. 2C, the information processor 200 according to various embodiments of the present disclosure may include the first application 220. The electronic device 101 according to various embodiments of the present disclosure may include a first application 220 for receiving a plurality of contents including first contents and second contents from at least one second application 230 and generating a third content that is different from the part of the first contents or the second contents based on the first contents or the second contents. The first application 220 may receive function information corresponding to at least a part of the first contents or at least a part of the second contents. The first application 220 may generate function information corresponding to at least a part of the third content, and the function information may include information for activating a function provided by a third application 210 receiving the third content, the electronic device, or an external device of the electronic device. The first application 220 may transmit at least some of the third content to the third application 210. When an attribute of the third application 210 or a state of the electronic device 101 executing the third application 210 corresponds to a first attribute or a first state, the first application 220 may transmit at least-some contents of the third application 210. When an attribute of the third application 210 or a state of the electronic device 101 executing the third application corresponds to a second attribute or a second state, the first application 220 may not transmit at least some contents of the third application 210.

When the electronic device 101 according to various embodiments of the present disclosure may include a first application 220 that receives contents from the second application 230, and may provide at least some of the contents with a first format through an output device functionally connected to the electronic device 101 when a state of the electronic device 101 or an attribute of the first application 220 corresponds to a first state or a first attribute, the electronic device, and provide at least some of the contents with a second format through the output device when a state of the electronic device 101 or an attribute of the first application 220 corresponds to a second state or a second attribute. The first application 220 may be described as a third application 210 in various embodiments of the present disclosure. The second application 230 may include an application executed in the electronic device. The second application may include an application executed in an external device of the electronic device. The first application 220 may receive function information related to the contents. The first application 220 may perform at least one function provided the electronic device 101 related to the contents or an external device of the electronic device 101 based on the function information. The first application 220 may automatically perform at least one function based on the state of the electronic device 101 or the attribute of the first application 220.

According to various embodiments of the present disclosure, one or more second applications 230 may exist, and the second application 230 may make contents for configuring information to be transmitted to the user and provide the made contents to the first application 220. Although the second application 230 exists within the electronic device 101 in FIG. 2 according to various embodiments of the present disclosure, the second application 230 may be included in a server connected to the network to be executed, or included in a peripheral device connected to the electronic device 101 or an external device of the electronic device 101 to be executed. The second application 230 may generate first contents or second contents and transmit the first contents or the second contents to the first application 220, or may transmit a plurality of contents including the first contents and the second contents to the first application 220.

According to various embodiments of the present disclosure, at least one of the second application 230 may determine a generation condition, an update condition, or a deletion condition of contents to be transmitted to the user, transmit the contents generated or updated according to the condition to the first application 220, or delete the contents registered in the first application 220. For example, the second application 230 of notification for providing a notification card of going to work/school may generate and provide corresponding contents at the same time every day. Furthermore, the contents may be deleted from the first application 220 by an input by the user or when a certain time elapses.

According to various embodiments of the present disclosure, each of the second applications 230 may generate, modify, or delete the contents to be provided, based on a designated event, such as a time, a place, and the like. For example, the second application 230 of email for providing an email notification card may generate or update the contents when a new email arrives and transmit the contents to the first application 220. Furthermore, the contents may be deleted from the first application 220 by an input by the user or when a certain time elapses.

The contents generated by the second application 230 will be described with reference to FIG. 3 below.

FIG. 3 illustrates contents according to various embodiments of the present disclosure.

Referring to FIG. 3, the contents correspond to a template of information transmitted to the user, and each content 301a may include function information 301b for activating a particular function. The contents may be configured in the form of text, image, sound or a combination thereof. The contents may include various fields or have elements, such as Description, title body1, body2, and the like. Furthermore, when the contents are generated, each of the elements may be assigned at least one of a security attribute, an exposure attribute, and a layer attribute.

According to various embodiments of the present disclosure, the contents may include elements of the contents, such as text and image as well as a type of the contents specifying a content type, a template specifying a data set, an expiration time, and an ID of the second application 230. Each of the elements of the contents may have the function information 301b executed by a user interaction.

According to various embodiments of the present disclosure, the function information 301b defines a function linked with the contents and corresponds to a part that defines an interface with the user for content information. For example, keeping in touch, making a call, viewing a map, transmitting an email, accessing a webpage, making payment and the like may correspond to the function information. When user interaction, such as a touch is generated, the function information 301b may execute a designated application, execute a service, or perform an operation of broadcasting particular data to external devices.

FIG. 4 illustrates a configuration of contents including a plurality of pieces of function information according to various embodiments of the present disclosure.

Referring to FIG. 4, content 1 may include function information corresponding to content 1 itself and text 1 or image 2, which is an element of content 1. At this time, through a touch for content 1, a touch for text 1, or a touch for image 2, a function corresponding to each piece of function information may be performed or activated.

According to various embodiments of the present disclosure, the type of each of the contents may be defined according to the substance and type of the contents. For example, each of “hotel reservation confirmation content”, “a tomorrow schedule preview content” and “missed call record view content” may correspond to the type of contents. The contents may be generated as a plurality of instances from one type. Furthermore, an expiration time during which the contents can be maintained may be configured. The expiration time refers to an effective time in which the contents are automatically deleted, and may be an absolute time or a relative time. When the expiration time corresponds to the absolute time, the expiration time may be a specific year/date/time/minute in which the contents are automatically deleted. When the expiration time corresponds to the relative time, the expiration time may be the time from a reference time of at least one of a time when the contents are transmitted from the second application, a time when the contents arrive at the first application 220, and a time when the contents arrive at the third application 210.

A configuration of the contents will be described through schedule contents as an example.

### i) Contents:

### >>Description: Today's Schedule

>>Title: Conference call with R&D

### >>Body 1: 9:30-11:20 AM

### >>Body 2: Seocho BD 11F Gold Room

>>Expiration time: 11:20 AM
ii) Function information:
1) Finding the way (in a case of the next schedule when a place is input): Activate a Google map application.
For example, when a body 2 field is selected, the Google map application is activated.
2) Transmitting a message to a participant: Activate a message application (only when there is a participant).
3) Having a good look: Activate an S planner application.

For example, when a title field is selected, the S planner application is activated.

According to various embodiments of the present disclosure, the first application 220 is a smart assistant and may be an entity that can store and manage contents generated by the second application 230 and transmit the contents to the third application 210. For example, when the first application 220 receives new contents from the third application 210, the first application 220 may inform the third applications 210 of the existence of the newly provided contents and the third applications 210 may receive information on the corresponding contents from the first application 220. At this time, the first application 220 may receive application of registration and subscription to know which type of contents will be received from each of the third applications in advance. When the second application 230 provide new contents, the first application 220 may inform the third applications 210 which have applied the registration and subscription of the type of corresponding contents according to information on the registration and subscription received in advance.

According to various embodiments of the present disclosure, an interface between the third application 210 and the first application 220 may be implemented through various methods. For example, the interface may be distributed to a library which can be used within the electronic device 101 and interwork within the device in an API call form, or may be provided in a Representational State Transfer (Restful) API form and configured as a remote interface between electronic devices having each of the third application 210 and the first application 200. The API call form refers to an interface that can be easily used by abstracting an Operating System (OS) or a particular function, such as a library required for developing an application program or a service. The interface may include an API of resource mainly related to the Internet, such as Single UNIX Specification, Windows API, Open API Web 2.0 API, communication service API or the like. The API opens resources that are required to be used in common by a plurality of people to the people, and users can easily use the resources without technical knowledge for the resources. The Representational State Transfer (Restful) API form refer to an interface which considers network component resources, such as contents (i.e., a text, an image, a video, and the like) as one resource, assigns an inherent Uniform Resource Identifier (URI) to each resource, and processes tasks of creating, reading, editing, and deleting the corresponding resource through HTTP standard commands, such as POST, GET, PUT, and DELETE.

According to various embodiments of the present disclosure, the third applications 210 having received the corresponding contents may provide the user with information configured as contents in accordance with a method of each of the third applications. Various embodiments of the present disclosure includes an example in which the first application 220 generates contents by using the first application 220 and the second application 230 which are separately provided, and provides the generated contents to the third application 210. Furthermore, in various embodiments of the present disclosure, a function by which the operation of the third application can be performed is integrated into the first application 220, so that the first application can equally perform the operation of the third application 210. For example, the first application into which the function by which the operation of the third application can be performed is integrated may generate contents and provide the user with information configured as the generated contents in accordance with a set method.

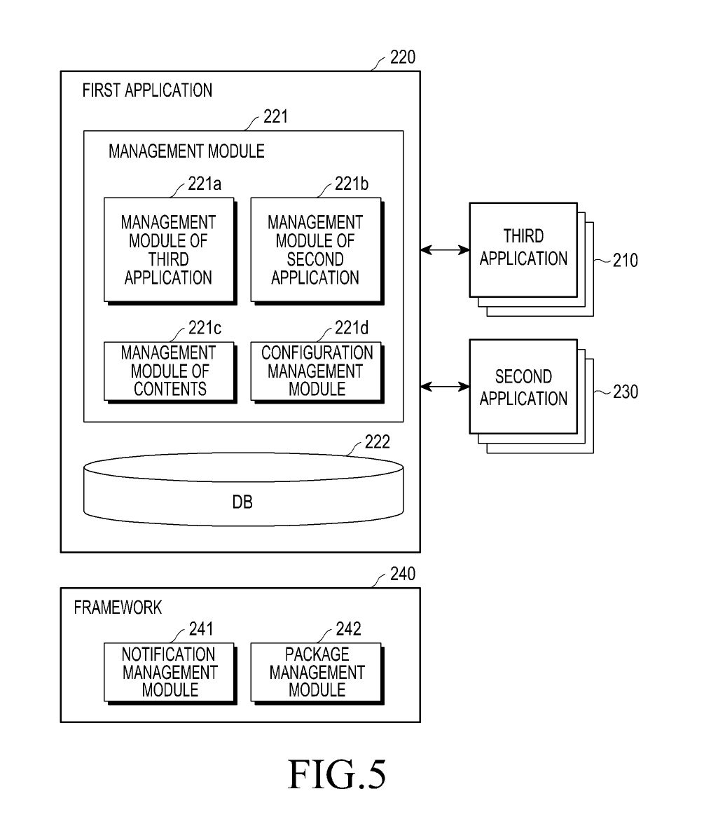

The configuration of the first application 220 will be described with reference to FIG. 5.

FIG. 5 illustrates a configuration of a first application of an electronic device according to various embodiments of the present disclosure.

Referring to FIG. 5, the first application 220 may include a management module 221 and a database unit 222. The database unit 222 corresponds to a module for storing information required to transmit the second application 230, the third application 210, and the contents. The database unit 220 may include, for example, a content DB 221c, a third application DB 221a, a configuration (Config) DB 221d, and a second application DB 221b.

The management module 221 corresponds to a module for receiving contents from the database unit 222 and the first application 220 and managing the received contents until the contents are transmitted to the third application 210. The management module 221 may include, for example, a configuration (Config) management module, a third application management module, and a first application management module. Specific components of each of the database unit 222 and the management module 221 will be described below.

1) Database unit

Content DB

can store contents provided from the first applications.

Third Application DB

can store information on the third applications registered in the first application.

Configuration DB

can store configuration (config) information on the second application and the type of contents which the third application desires to receive. Each piece of configuration (config) information may include a combination of the second application, the type of contents, and the third application.

Ex.) [_id][second application][content type][third application][section][isSubscribed]

Second Application DB

can store information on the second applications registered in the first application.

Content Type DB

can manage information the types of contents registered in the first application. The information on the types of contents may include a name of the second application which generates the corresponding type of application, a name of the type of contents, a display name for each language of the content type, an explanation of the content type for each language, and a sample image of the content type.

### 2) Management Module

Content Management Module

The content management module corresponds to the part for managing overall processing of contents stored in the content DB, such as registration, search, editing, or deletion, and can manage a life-cycle of the contents with reference to a request related to the contents and an expiration time of the contents of the second application and the third application.

Configuration (Config) Management Module

When the third application makes a request for subscribing to/unsubscribing the particular content type of the particular first application, the configuration management module can receive the request and change subscription information of the third application. The configuration management module may notify changed contents of the subscription information and manage setting information indicating the content type of the second application that is associated with each of the third applications. Accordingly, each of the third applications can select whether to receive (subscribe to) information on newly generated contents.

The subscription information of the configuration management module may be controlled through the second application remotely provided. For example, when the second application remotely provided does not provide the type of contents any more or a provided contract term expires, the subscription information on the corresponding content type may be remotely changed to be unsubscribed. Furthermore, the configuration management module may manage mapping table for the type of contents for each second application, which can be supported for each third application currently provided. For example, when the third application corresponds to a device having a small screen, such as a smart watch, the second application may have no content type, which can be provided to the third application having the small screen. In this case, the configuration management module may inform the third application that the second application cannot be provided to the corresponding third application. Alternatively, when the second application has the content type, which can be provided in a particular area, for example, the U.S.A. and the third application is located at an area that is not the U.S.A, the configuration management module may inform the third application that the content type of the second application cannot be provided to the third application.

Third Application Management Module

The third application management module can manage information on the third application, such as creating, editing, or deleting the information on the third application registered in the first application. Furthermore, the third application management module may perform a function of providing the second application with base information related to the third application such a name of the third application, a screen size, a maximum size of the contents, or a color depth. In addition, when the registered third application is deleted, the third application management module may delete the information related to the third application and inform the second application of the deletion.

Second Application Management Module

The second application management module can manage base information related to the second application, such as creating, editing, or deleting the information on the second application registered in the first application. The information related to the second application may include information on a package name of the second application, a display name for each language, and an icon. The second application may remotely provide contents at the outside of the electronic device. In a case of the remotely provided second application, when the content type is added, deleted, or changed, the second application management module may inform the first application of the corresponding matter reflect the corresponding matter in the third application. For example, when a new content type provided by the second application is created, the second application management module may inform the first application of the changed matter to allow the third application to receive the newly provided contents. Alternatively, when at least one of the substance or form of the content type of the second application and user interaction is changed, the corresponding matter may be notified to the first application and the changed matter may be reflected in the contents which have been already provided from the third application. Alternatively, when the contract period of the second application is expired, the corresponding matter may be notified to the first application and the contents that have been already provided from the third application may be deleted.

The operation of the first application according to various embodiments of the present disclosure may include (1) registering the third application, (2) registering and subscribing to the content type of the third application, (3) registering the second application, (4) registering the content type of the second application, (5) generating contents of the second application, (6) transmitting contents of the second application, (7) updating contents of the second application, (8) refreshing contents of the third application, and (9) deleting contents. The operations of the first application will be described below.

### (1) Registration of Third Application

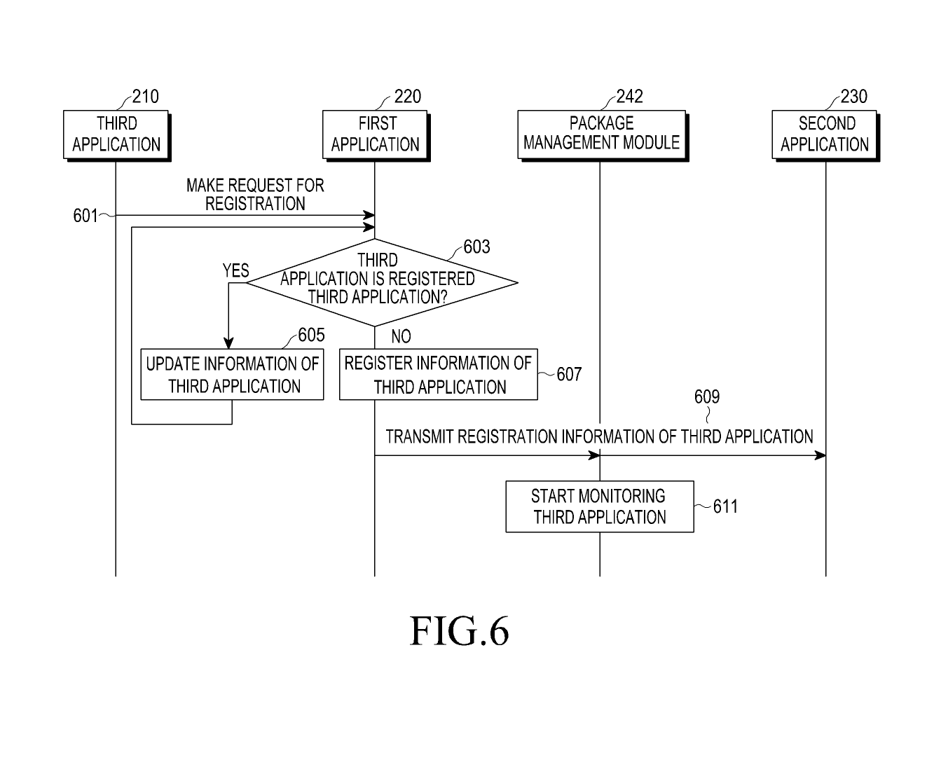

The operation in which the first application registers the third application will be described below with reference to FIG. 6.

FIG. 6 illustrates an operation in which a first application registers a third application according to various embodiments of the present disclosure.

Referring to FIG. 6, the third application 210 may make a request for the registration to the first application 220, to receive contents from the first application 220 in operation 601. At this time, the third application 210 may make a request for registering additional information of the third application together with a name of the third application 210. The additional information may include at least one of a screen width (pixel), a screen height (pixel), a maximum contents width (pixel), a maximum contents height (pixel), a minimum contents width (pixel), a minimum contents height (pixel), a dpi, a bpp (bit per pixel), and whether a sound is supported.

When the registration is requested from the third application 210, the first application 220 may identify whether the third application 210, which requests the registration, is a third application which has been already registered, through the content management module 221c in operation 603. When it is identified that the third application 210 is the third application that has been already registered in operation 603, the first application 220 may update related information received from the third application, for example, additional information in operation 605. Alternatively, when it is identified that the third application 210 is a third application which has not been registered in operation 603, the first application 220 may store related information received from the third application, for example, a name of the third application or additional information in operation 607.

When the third application 210 is registered in the first application 220, the first application 220 may transmit the registration of the third application 210 to a package management module 242 of a framework 240 in operation 609. The framework 240 includes a notification management module 241 and the package management module 242. In operation 611, the package management module 242 may include the third application 210 as a target to be installed or removed and may monitor the third application 210. When the removal of the third application 210 is informed through the monitoring by the package management module 242, the first application 220 may delete related information of the third application 210, for example, the name or additional information.

Furthermore, when the third application 210 is registered in the first application 220, the first application 220 may transmit related information of the third application 210, for example, the name of the third application or additional information to the second application 230 in operation 609. The second applications 230 may identify the related information of the third application received through the first applications and identify the types of registered third applications 210 or refer to the identified information when setting a target to receive contents.

### (2) Registration and Subscription of Content Type of Third Application

According to various embodiments of the present disclosure, the successfully registered third application 210 may register in advance the content type, which is to be provided to the third application 210 through a registration process of the content type, in the first application 220. The registration process of the content type may be performed in such a manner that the third application 210 provides the content type which the third application 210 desires to the first application 220 or the first application 220 provides currently registered content information to the third application 210 to allow the third application 210 to select the content type. The first application 220 may manage the content type registered by the third application 210 together with information on the second application 230 that provides the registered content type. The third application 210 may or may not receive selectively some of the content types registered by the third application 210 through the subscription to the content types. Subscription information of the third application 210 may be managed with a correlation between the content type of which the subscription is applied and the second application 230 providing the content type of which the subscription is applied.

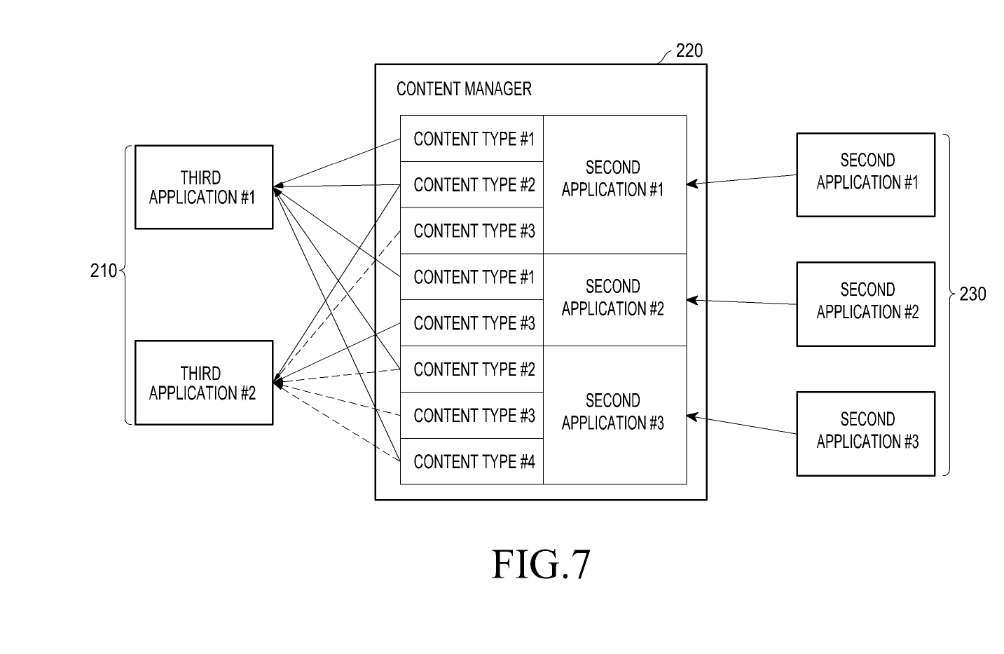

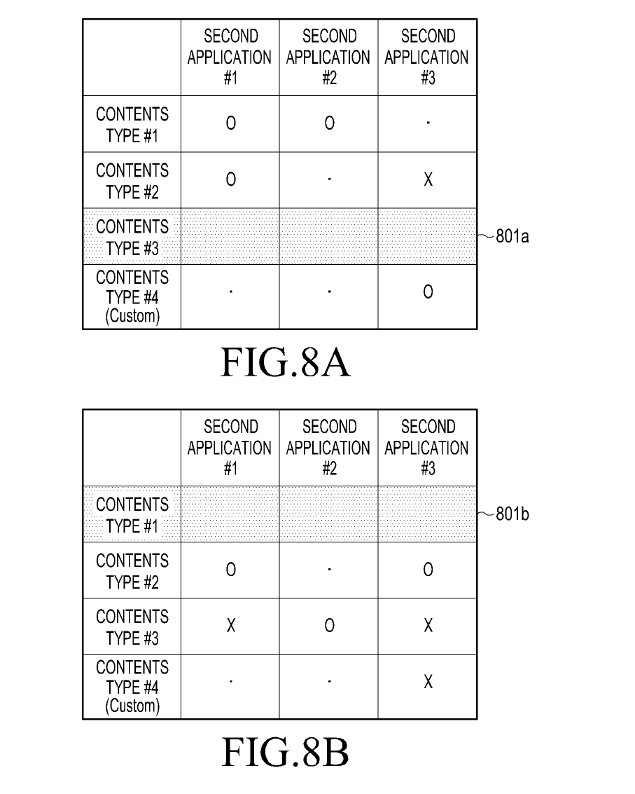

FIGS. 7 to 8B illustrate a plurality of content types registered in a second application or subscribed to by the second application according to various embodiments of the present disclosure. FIGS. 7, 8A, and 8B illustrate a case where some of the contents are subscribed in a state in which the third application registers a plurality of content types. First, FIG. 7 is a conception diagram in which each of the third applications receives contents types provided from each of the second applications.

Referring to FIG. 7, an arrow which points the third application indicates that the corresponding content type has been registered. Furthermore, a solid line arrow indicates subscription, and a dotted line arrow indicates a non subscription state.

FIGS. 8A and 8B illustrate an embodiment in which each of third application #1 and third application #2 manages content types. FIG. 8A illustrates a DB of third application #1 and FIG. 8B illustrates a DB of third application #2.

Referring to FIGS. 8A and 8B, “o” indicates a content type which can be provided by the second application and “.” indicates a content type which cannot be provided by the second application. Furthermore, “x” indicates a content type that is registered by the third application but has not been subscribed. In addition, reference numerals “801a” and “801b” indicate content types that are not registered by the third application. The operation in which (2) the first application registers and subscribes to the content types of the third application may include 1) an operation of registering/non-registering content types for each third application, 2) an operation of subscribing to/releasing the subscription to contents for each third application, and 3) an operation of providing custom content types.

Among operations of the first application, an operation of registering and subscribing to content types by the third application will be described below through various embodiments of the present disclosure.

### 1) Registration/Non Registration of Contents by Each Third Application

Referring to FIG. 7, third application #1 registers content types #1, #2, and #4 through a content registering process and does not register content type #3. However, third application #2 registers content types #2, #3, and #4 and does not register content type #1. As described above, each of the third applications may optionally select content types which each of the third applications desires to receive.

2) Subscribing to/Unsubscribing from Contents by Each Third Application

Referring to FIG. 7 and FIGS. 8A and 8B, with respect to content type #1 which third application #3 receives, third application #3 receives both content type #1 provided by second application #1 and content type #1 provided by second application #2. Furthermore, with respect to content type #2 which third application #1 receives, third application #1 receives content type #2 provided by second application #1, but does not receive content type #2 provided by second application #3. As described above, the third applications may subscribe to some of the plurality of content types provided one second application which the third applications desire to receive, and may unsubscribe some of the content types which the third applications does not desire to receive.

### 3) Provision of Content Types

Third application #1 receives content type #4 (customized contents) generated by second application #3, and third application #2 registers content type #4, but second application #3 does not receive content type #4. As described above, each of the third applications may or may not receive selectively content types generated by the second applications.

### (3) Registration of Second Application

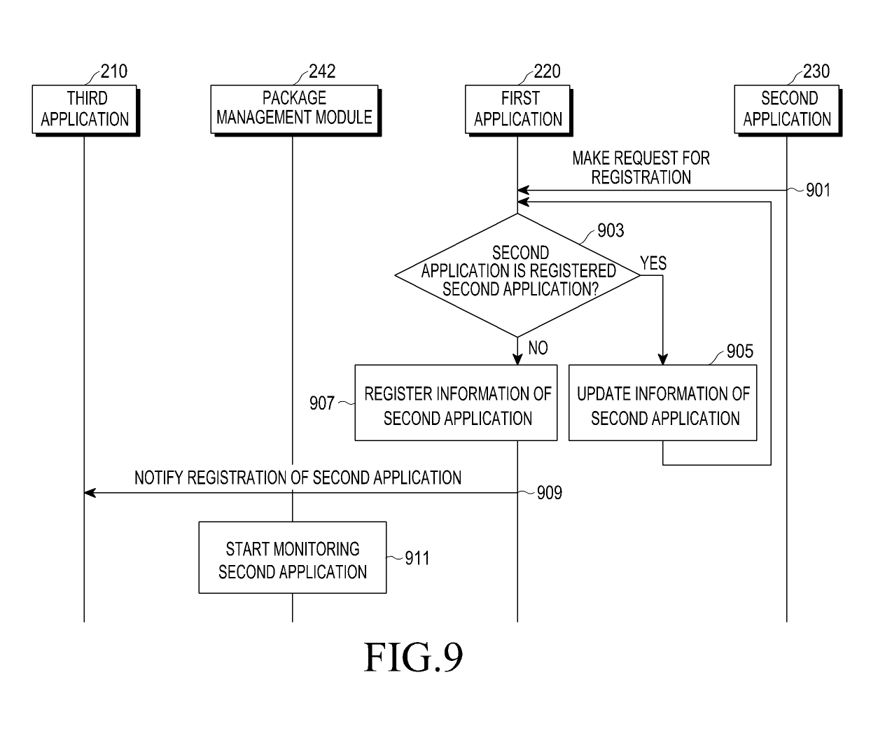

The operation of the first application with respect to the registration of the second application will be described below with reference to FIG. 9.

FIG. 9 illustrates an operation in which a first application registers a second application according to various embodiments of the present disclosure.

Referring to FIG. 9, the second application 230 may make a request for registering contents generated by the second application 230 in the first application 220 to provide the contents to the user in operation 901. When the registration request is received from the second application 230, the first application 220 may identify a name of the second application 230 through the second application management module 221b to identify whether the second application 230 is a second application that has been already registered in operation 903. When it is identified that the second application 230 is the second application that has been already registered in operation 903, the first application 220 may update related information received from the second application, for example, additional information of the second application in operation 905.

Alternatively, when it is identified that the second application 230 is an application that has not been registered in operation 903, the first application 220 may store related information received from the second application 230, for example, a name of the second application or additional information in operation 907.

When the second application 230 is registered in the first application 220, the first application 220 may transmit the registration of the second application 230 to the package management module 242 of the framework 240 in operation 909. In operation 911, the package management module 242 may include the second application 230 as a target to be installed or removed, and may monitor the second application 230. When the removal of the second application 230 is informed through the monitoring by the package management module 242, the first application 220 may delete related information of the second application 230, for example, the name or additional information. For example, when the user deletes the second application in a state where a second schedule application provides schedule contents to a third home screen application in the form of content type #1, the first application 220 may inform of the deletion of the second application through the package management module 242 and delete the corresponding second schedule application and related information.

Furthermore, when the second application 230 is registered in the first application 220, the first application 220 may transmit related information of the second application 230, for example, the name of the second application or information on the content type provided by the second application to the third application 210 in operation 909. The third applications 210 may identify the related information of the second application received through the first applications and identify the types of newly registered second applications or refer to the identified information when registering or subscribing to contents provided by the second application.

### (4) Registration of Content Type of Second Application

According to various embodiments of the present disclosure, the successfully registered second application may register in advance the content type, which is provided by the second application itself through a registration process of the content type, in the first application. The registration process of the content type may be performed through a method in which the second application provides the content type, which the second application desires to the first application or a method in which the first application provides information on currently registered content types to the second application to allow the second application to select the content type. At this time, the second application may identify information on the registered third applications through the first application, designate the third application to receive the contents provided by the second application, and provide the contents to the designated third application. When the second application does not designate the third application, which will receive the contents provided by the second application, the contents might be provided to all the third applications registered in the first application. The content types registered in the first application may be transmitted to the third application by the first application so that the third application may dynamically select whether to subscribe to the corresponding content type generated by the second application or not.

### (5) Registration of Content Type of Second Application

According to various embodiments of the present disclosure, the second application may generate a new content type that has not been registered in the first application. At this time, the second application may also transmit information on a name of the content type, a display name for each nation, preview, and description for each nation to the first application. The generated content type may be transmitted to another second application by the first application, and other second applications may use the corresponding content type according to the intention of each of the second applications. Furthermore, even though the second application having generated the content type is removed, information on the corresponding content type may be maintained in the first application until another second application being used is removed.

### (6) Transmission of Contents by Second Application

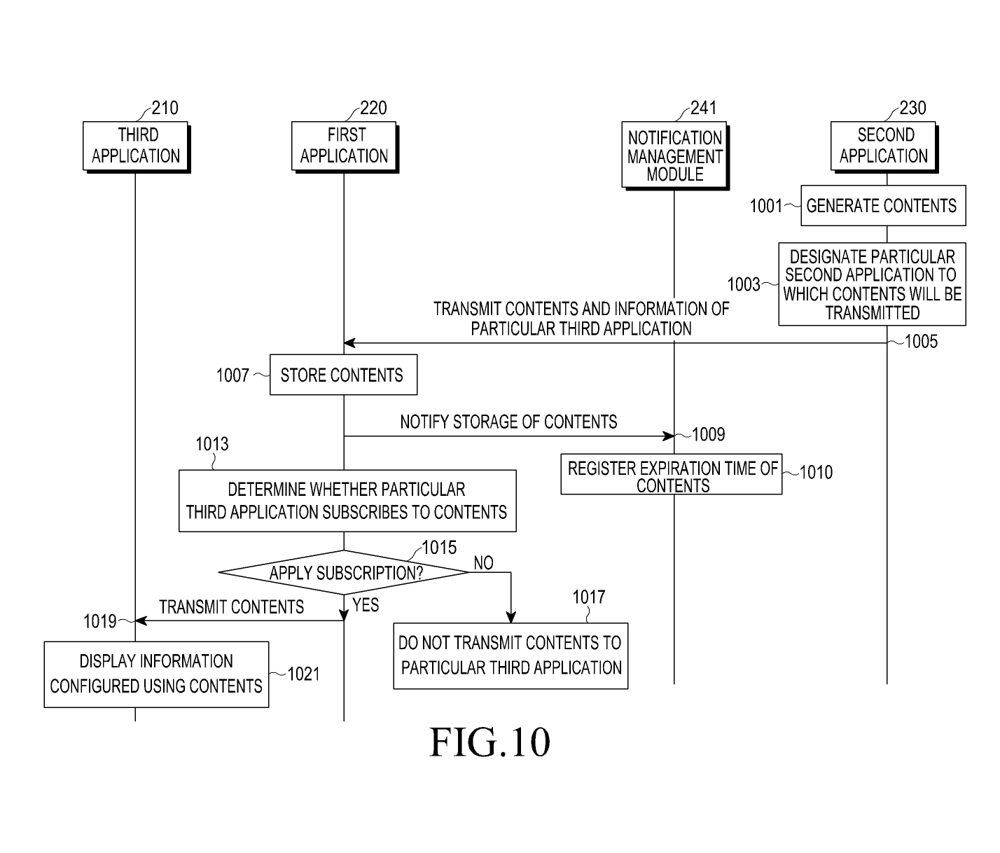

The operation of the first application with respect to the transmission of contents by the second application will be described below with reference to FIG. 10.

FIG. 10 illustrates an operation in which a first application transmits contents of a second application according to various embodiments of the present disclosure.

Referring to FIG. 10, in operation 1001, the second application 230 may generate new contents for content types registered in the first application 220.

In operation 1003, the second application 230 may designate a particular third application providing the generated contents. In this case, the second application may generate more customized contents and transmit the generated contents to the particular third application 210. That is, unlike a case where contents are transmitted to a plurality of third applications, customized contents are generated by cropping an image through the use of more information, such as a screen size, resolution, or dpi of the particular third application or making a more specific text description read by voice, and the generated contents are transmitted to the customized third application 210.

In operation 1005, the second application 230 may transmit the generated contents and information on the particular third application 210, for example, a name of the particular third application to the first application 220. In operation 1007, the first application 220 may store contents received from the second application 230 in a content DB. When the contents stored in the content DB has an expiration time, the first application 220 may inform the notification management module 241 of the framework 240 of the storage of the contents in operation 1009 in order to delete the contents when the expiration time arrives. In operation 1010, the notification management module 241 may register the expiration time of the contents. The notification management module 241 registers one expiration time that is closest to the current time without registering expiration time of all contents. When the corresponding expiration time arrives, the notification management module 241 may repeat the above operations with respect to expiration time of the remaining contents after the corresponding contents are deleted.

In operation 1013, the first application 220 may determine whether the particular third application 210 subscribes to the contents provided by the second application 230. Furthermore, when it is determined that the particular third application 210 does not subscribe to the contents provided by the second application 230 in operation 1015, the first application 220 may not transmit the contents provided by the second application 230 to the particular third application in operation 1017. However, when it is determined that the particular third application 210 subscribes to the contents provided by the second application 230 in operation 1015, the first application 220 may transmit the contents provided by the second application 230 to the particular third application in operation 1019.

In operation 1021, the particular third application 210 may provide information configured as contents to the particular third application 210 through the most effective method.

Furthermore, when the second application 230 provides the contents to the first application 220 without designating the particular third application, the first application 220 may first detect third applications that subscribe to content types provided by the second application 230. Furthermore, the first application 220 may transmit contents provided by the second application to the detected third applications.

### (7) Update of Contents by Second Application

According to various embodiments of the present disclosure, with respect to contents registered in the first application, the second application may update function information of the contents, text corresponding to components of the contents, and an image. When the second application updates information of the contents, the first application may transmit information on the update of the contents to the third applications that subscribe to the corresponding contents.

### (8) Refresh of Contents by Third Application

According to various embodiments of the present disclosure, the third application may make a request for refreshing particular contents or all content types of which subscription has been requested to the second applications providing the particular contents or all content types. Such a request may be transmitted to the second application through the first application.

### (9) Deletion of Contents

According to various embodiment of the present disclosure, the contents may be deleted in at least one of a case where there is an explicit request for deleting the contents, a case where the second application having transmitted the corresponding contents directly deletes the contents, a case where an expiration time stated in the contents has passed, a case where an acceptable storage capacity of the content DB is exceeded, and a case where the second application having transmitted the contents is deleted.

According to various embodiments of the present disclosure, the first application 220 may generate new contents by using a plurality of contents provided by the second application 320 and provide the newly generated contents to the third application 210.

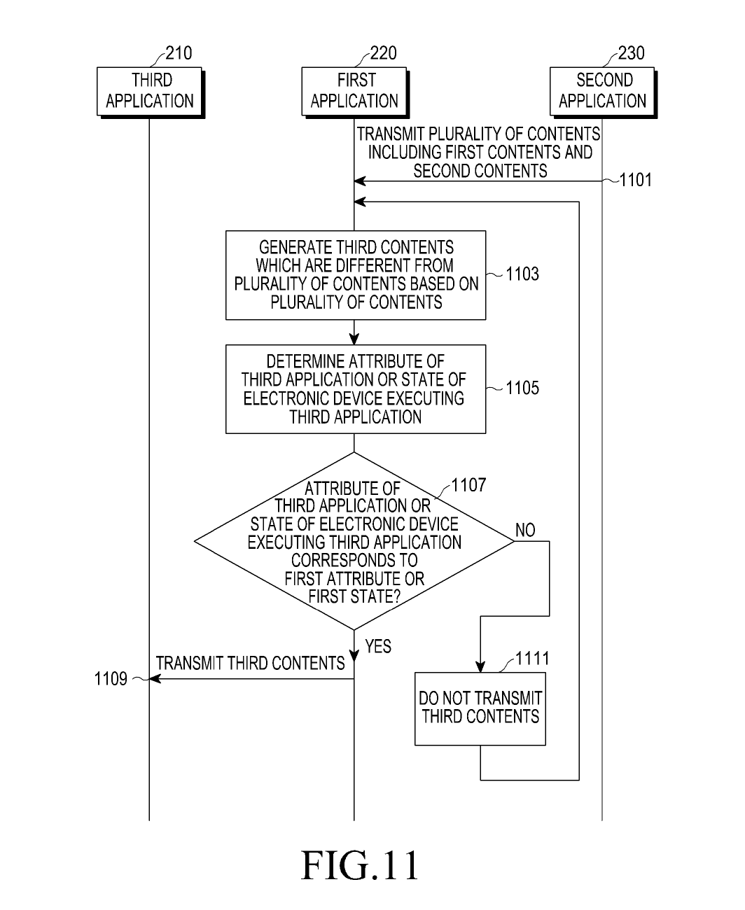

An operation in which the first application 220 generates contents and transmits the generated contents to the third application will be described below with reference to FIG. 11.

FIG. 11 illustrates an operation in which a first application generates contents and provides the generated contents to a third application according to various embodiments of the present disclosure.

Referring to FIG. 11, the first application 220 may receive single content or first contents and second contents from the second application 230 in operation 1101. In operation 1103, the first application 220 may generate a new third content which is different from the first contents and the second contents by using at least the part of the first contents and the second contents included in a plurality of contents according to a set condition.

In operation 1103, the first application 220 may receive function information corresponding to at least the part of the first contents, that is, a particular element among the elements of the first contents, or function information corresponding to at least the part of the second contents, that is, a particular element among the elements of the second contents from the second application 230. The set condition for generating the third content may include at least one of a content detection reference condition, a generation time condition, and a generation method condition.

According to various embodiments of the present disclosure, the content detection reference condition may include a content detection reference condition detected for generating the third content among a plurality of contents provided by the second application 230 and stored in the content DB. The content detection reference condition may include at least one of a non-transmitted content reference, a particular time reference, a user setting reference, a particular second application 230 reference and a content update cycle reference.

The non-transmission content reference may include a reference for detecting contents that are stored in the content DB of the first application 220, but not provided to the third application 210, as contents for generating the third content. The particular time reference may include a reference by which a certain number or more of the same contents that are received from a plurality of second applications within a particular time is detected as the contents for generating the third contents. Since each of the second applications does not know subscription information of contents of the third application, a certain number of same contents or more may be intensively provided from a plurality of second applications for a particular time. For example, when the third application 210 subscribes to a content type of Olympic ski, the first application 220 may intensively receive contents of the Olympic ski to be provided to the third application 210 from each of a plurality of second applications.

The user setting reference may include a reference for detecting contents for generating the third content according to each content type selected by the user or each third application 210 selected by the user. The particular second application reference may include a reference for detecting contents of the set particular third application 210 as contents for generating the third content. When the contents provided by the particular second application 230 is provided to the user by the third application 210 through the first application, but the user has not identified the contents for several days, the contents may be accumulated. Thereafter, the first application 220 may detect the non-identified contents provided to the particular second application 230 as contents for generating the third content. For example, in a premium service of Kakao talk, when a user has not identified provided contents for several days, many contents may be accumulated. In order to prevent such a case, the non-identified contents provided by the premium service of Kakao talk may be detected as contents for generating the third content. When the first application 220 provides the third content generated using the non-identified contents to the third application, the third application 210 may delete the non-identified contents.

The content update cycle reference may detect contents having similar update cycles among a plurality of contents provided by a plurality of second application 230 as contents for generating the third contents. For example, when an update cycle corresponds to every morning, at least one of today morning news contents and performance information contents may be detected as contents for generating the third content. Alternatively, when an update cycle corresponds to every month, this month's sports information content or at least one of this month's sports information content may be detected as contents for generating the third contents.

According to various embodiments of the present disclosure, the generation time condition may include a condition at a time point when the third content can be generated using a plurality of contents provided by the second application 230. The generation time condition may include at least one of a set content number of a set period.

The set content number may include a reference number by which the detected contents may be generated as the third contents according to the content detection reference condition. For example, in a case where the set number of contents is 100, if the number of contents detected according to the content detection reference condition becomes 100, the third contents may be generated using the 100 contents.

Furthermore, the set number of contents may be configured according to each third application 210. For example, in a case where the number of contents detected according to the non-identified content condition of the content detection reference condition is 100, if the number of contents which have not been transmitted to the third application 210 of the first electronic device is 20 and the number of contents which have not been transmitted to the third application 210 of the second electronic device communicating with the first electronic device is 80, the set number of contents according to each third application 210 or the set number of contents which are integrated into the third application 210 of the first electronic device and the third application 210 of the second application 230 may be determined. When the set number of contents for the third application 210 of the first electronic device is 80 and the set number of contents for the third application 210 of the second electronic device is 15, the third contents to be provided to the third application 210 of the first electronic device may be generated using the 80 contents. Alternatively, when the set number of contents which are integrated into the third application 210 of the first electronic device and the third application 210 of the second electronic device is 120, the third contents to be provided to the third application 210 of the first electronic device may be generated using the 80 contents and the third contents to be generated to the third application 210 of the second electronic device may be generated using the 20 contents.

The set period may include a particular period for which the third contents can be generated using the periodically detected contents according to the content detection reference condition. For example, the third contents may be generated using non-transmitted contents per week. Furthermore, the set period may include a particular time for a certain number of same content types or more is received. When the number of same content types provided from a plurality of second applications within the particular time is greater than or equal to a certain number, the third contents may be generated using contents which become greater than or equal to the certain number within the particular time. For example, when a certain number of sport contents, for example, 20 or more sports contents are received from different sports second applications for 30 minutes, the third contents may be generated using the 20 sports contents.

According to various embodiments of the present disclosure, the generation method condition may include a method of generating the third contents by using the detected contents according to the content detection reference condition and the generation time condition. The generation method condition may include a third content generation unit which classifies the detected contents according to the content detection reference condition and the generation time condition in the unit, and generate the third contents by using the classified contents.

When the third content generation unit corresponds to a number unit, the detected contents may be classified into a certain number of contents, for example, 5 or 10 contents and each of the classified contents may be generated as the third content. Furthermore, when the third content generation unit corresponds to each content type or each third application, each of the contents classified according to the content type, for example, the notification content type (provided by each of the S notification third application 210 or the V notification third application) or each third application, for example, the heath third application 210 may be generated as the third contents.

According to various embodiments of the present disclosure, the generation method condition may configure the type of third contents. When the third contents are generated according to each same content among the contents detected according to the content detection reference condition and the generation time condition, type information of the same content may be added to the third contents. For example, when the third contents are generated using sports contents, type information, such as “sports” may be added to the third contents. The third application 210 receiving the third contents may classify the third contents as the sports contents through the type information added to the third contents.

According to various embodiments of the present disclosure, when the third contents are generated using different contents among the contents detected according to the content detection reference condition and the generation time condition, the contents may be classified according to the most recently received content type reference or a most frequently received content type reference and the third contents may be generated using the classified contents. Furthermore, type information of the most recently received contents or type information of the most frequently received contents may be added to the third contents. In addition, type information indicating that the third contents correspond to new type contents, for example, abstract contents may be added to the third contents generated using a plurality of sports contents or the third contents generated using the content type most recently received or the content type most frequency received, and the third contents with the type information may be transmitted to the third application 210.

According to various embodiments of the present disclosure, the generation method condition may include a method of generating the third contents based on the substance of the contents. The contents may be classified according to the substance of the contents detected based on the content detection reference condition and the generation time condition, for example, a transmitter (sender), and the third contents may be generated using the classified contents. For example, in the case of Twitter/Facebook/e-mail, the contents for generating the third contents may be classified according to names written in alphabetical order of senders (transmitters) who make and send each Twitter/Facebook/e-mail.

According to various embodiments of the present disclosure, the generation method condition may include a method of generating the third contents based on the importance of the contents. Positions displayed in the third contents may be determined based on the importance of respective contents detected according to the content detection reference condition and the generation time condition. The importance of each of the contents may be determined based on a past transmission/reception history or a storage history of the first application, based on the importance of a sender (transmitter) of the contents, or based on a set content type or a set third application 210. In a case of the importance of the sender (transmitter), for example, in a case of Twitter/Facebook/e-mail, the importance of the sender may be determined based on the number of times the sender makes each of Twitter/Facebook/e-mail.

According to various embodiments of the present disclosure, the generation method condition may include a method of configuring the third contents. The contents may include various fields and have elements, such as Description, Title body1, body2, and the like. The third contents may include particular elements detected from among elements of each of the contents detected according to the content detection reference condition and the generation time condition. For example, when “Title” is configured as a particular element for configuring the third contents among the elements of the contents, the contents including “Title” to be detected from each of a plurality of contents may be generated and transmitted to the third application 210. When the third application 210 selects particular “Title” in the third contents, the first application 220 may provide contents including the selected particular “Title” to the third application 210. Furthermore, the third contents may be generated using attribute information of the contents detected according to the content detection reference condition and the generation time condition. The third contents may be configured using, as the attribute information, at least one of text, image, and video included in each of the contents detected according to the content detection reference condition and the generation time condition. For example, when the image is used as the attribute information, the third contents may be generated by configuring each of the contents detected according to the content detection reference condition and the generation time condition in a thumbnail form.

According to various embodiments of the present disclosure, the generation method condition may include a method of configuring function information in the third contents. The first application 220 may generate function information corresponding to at least some of the third contents, that is, at least one of a plurality of contents included in the third contents. The function information is information for activating a function provided by the third application 210 receiving the third contents, the first electronic device executing the third contents, or the second electronic device which is an external device communicating with the first electronic device. The function information may include information for switching a sleep state of the first electronic device or the second electronic device to a wake up state.

According to various embodiments of the present disclosure, in the method of configuring the function information in the third contents, when the third contents are generated using the contents detected according to the content detection reference condition and the generation time condition, the function information provided by the second application 230 having generated each of the plurality of contents included in the third contents may be equally configured. For example, when the third contents include the Title of the first contents and Title of the second contents, function information on the execution of a Google Map application in which the Title of the first contents is configured may be equally configured or function information on the execution of an S planner application in which Title of the second contents are configured may be equally configured.

According to various embodiments of the present disclosure, in the method of configuring the function information in the third contents, when the third contents are generated using the contents detected according to the content detection reference condition and the generation time condition, function information may be newly configured by the first application 220. For example, when the third contents are generated using 5 contents, the third contents may be generated by detecting Title of each of the 5 contents and new function information which can be loaded through a connection between each of Titles and the corresponding contents may be configured. Furthermore, the first application 220 may generate and configure not only function information but also additional information in the third contents. When the function information configured in the third contents may not be performed in the first electronic device, which is executing the third application 210 receiving the third contents, the additional information may include control information by which the function information can be executed using the second electronic device connected to the first electronic device. When the third contents are provided to the second electronic device, for example, a wearable device, additional information by which the second electronic device can control the first electronic device may be configured in the third contents. When the function information configured in the third contents provided to the second electronic device corresponds to full browsing, the second electronic device having a small screen may make a request for the full browsing to the first electronic device. When the function information configured in the third contents provided to the second electronic device corresponds to navigation application execution, the second electronic device having a small screen may make a request for the navigation application execution to the first electronic device. When there are coupon card contents in the third contents provided to the second electronic device, the second electronic device, which does not include a model or NFC function may transmit barcode information or payment information by using the first electronic device and display the payment information on a screen of the first electronic device having a large screen.

According to various embodiments of the present disclosure, when the third contents are provided to the first electronic device, additional information by which the first electronic device can control the second electronic device may be configured in the third contents. The first electronic device may control the second electronic device to perform the function information configured in the third contents while performing the function information by using the additional information. For example, when the first electronic device displays a navigation application execution screen according to the performance of the function information configured in the third contents, the first electronic device may control the second electronic device to recognize a voice output or a voice input by the user according to the navigation application execution screen. Furthermore, when the first electronic device and the second electronic device may perform the same function, the first electronic device may provide the function information so the user can select the first electronic device or the second electronic device which can perform the function information configured in the third contents. In addition, the second electronic device may provide the function information, so the user can select the first electronic device or the second electronic device which can perform the function information configured in the third contents.

When new third contents are generated through operation 1103, the first application 220 may determine an attribute of the third application 210 to which the third contents will be provided or a state of the electronic device executing the third application 210 in operation 1105. The attribute of the third application 210 may include a first attribute and a second attribute. The first attribute corresponds to a state where the execution of the third application 210 is activated and the second attribute corresponds to a state where the execution of the third application 210 is deactivated.

The state of the electronic device may include a first state and a second state. The first state may indicate a state where power of the electronic device is turned on or a good communication state between the electronic device registered in the first application 220 and another electronic device communicating with the electronic device, for example, a wearable device. Furthermore, the second state may indicate a state where power of the electronic device is turned off or a bad communication state between the electronic device registered in the first application 220 and another electronic device communicating with the electronic device, for example, a wearable device.

When it is determined that the attribute of the third application 210 or the state of the electronic device executing the third application 210 corresponds to the first attribute or the first state in operation 1107, the first application 220 may transmit the third contents to the third application 210 in operation 1109. However, when it is determined that the attribute of the third application 210 or the state of the electronic device executing the third application 210 does not correspond to the first attribute or the first state in operation 1107, the first application 220 may not transmit the third contents to the third application 210 and stand by until the attribute of the third application 210 or the state of the electronic device becomes the first attribute or the first state in operation 1111.

While the first application 220 stands by until the attribute of the third application 210 or the state of the electronic device becomes the first attribute or the first state, the first application 220 may generate the third contents by using contents which are not transmitted for the standby in operations 1103 and 1105. For example, when it is assumed that the user has a main first electronic device and a watch type second electronic device and when the third application 210 which can receive contents from the first application 220 is registered in both the electronic device, a communication state between the two devices may be bad or the execution of the third application 210 of one electronic device may be deactivated. In this case, the contents may not be transmitted to each of the third applications and continuously accumulated in the first application 220.

In the above case, when the user activates the execution of the third application 210 or the communication state between the two devices becomes good, the contents, which have not been transmitted to the third application, may be transmitted to the third application 210 together. When the contents, which have not been transmitted to the third application, are transmitted to the third application 210 together, since the user receives the large number of contents at a time, the user may have a difficulty in identifying the contents which the user desires among the large number of contents and may receive contents that the user does not desire in some cases, thereby significantly increasing the use of data.

As described above, when the electronic device 101 cannot receive the large number of contents, the first application 220 generates the large number of contents, which have not been identified, as new third contents and provides the new third contents through the operation of FIG. 11 according to various embodiments of the present disclosure, so that the user can effectively view information on the large number of contents (for example, the first application 220 compresses 20 non-transmitted contents into third contents corresponding to one abstract content and then transmits the third contents). Furthermore, when the user selects information on the contents that the user desires to view from information on the large number of contents, the first application 220 may provide actual contents corresponding to the selected content information to the third application 210.

A method of providing information by an electronic device 101 according to various embodiments of the present disclosure may include an operation in which a first application 220 executed in the electronic device 101 receives a plurality of contents including first contents and second contents from at least one second application 230 and an operation in which the first application 220 generates a third content which is different from at least the part of the first contents or the second contents based on the first contents or the second contents. The operation in which the first application 220 executed in the electronic device 101 receives the plurality of contents may include an operation in which the first application 220 receives function information corresponding to at least the part of the first contents or at least the part of the second contents. The operation in which the first application 220 generates the third content may include an operation in which the first application 220 generates function information corresponding to at least the part of the third content, and the function information may include information for activating a function provided by a third application 210 receiving the third content, the electronic device, or an external device of the electronic device. The method may further include an operation of transmitting at least the part of the third content to the third application 210. The operation of transmitting at least the part of the third content may include an operation of transmitting at least the part of the third application 210 when an attribute of the third application 210 or a state of the electronic device 101 executing the third application 210 corresponds to a first attribute or a first state and an operation of refraining from transmitting at least the part of the third application 210 when an attribute of the third application 210 or a state of the electronic device 101 executing the third application 210 corresponds to a second attribute or a second state.

The third application 210 is an entity for providing the user with generated contents by the second application 230 and may receive contents from the first application 220. The third application 210 may be a kind of application for providing information included in the contents to the user and an interaction with the user by using the received contents and function information included in the contents. The third application 210 may select at least one element from the content elements for providing the received contents to the user and may perform a function of matching the configured function information with the selected element among the content elements.

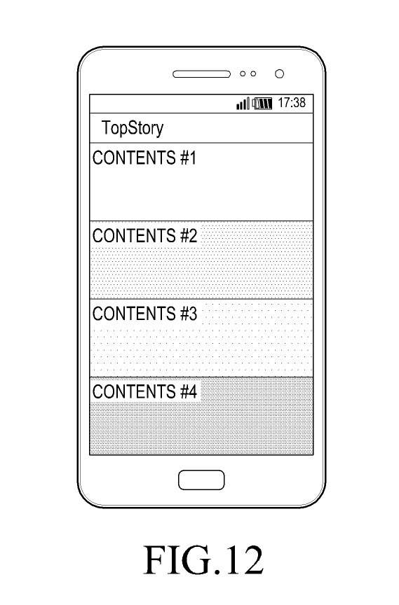

FIG. 12 illustrates a third application installed in an electronic device according to various embodiments of the present disclosure.

Referring to FIG. 12, four display areas are illustrated in which content #1 to content #4 provided by a plurality of third applications installed in the electronic device 104 can be displayed.

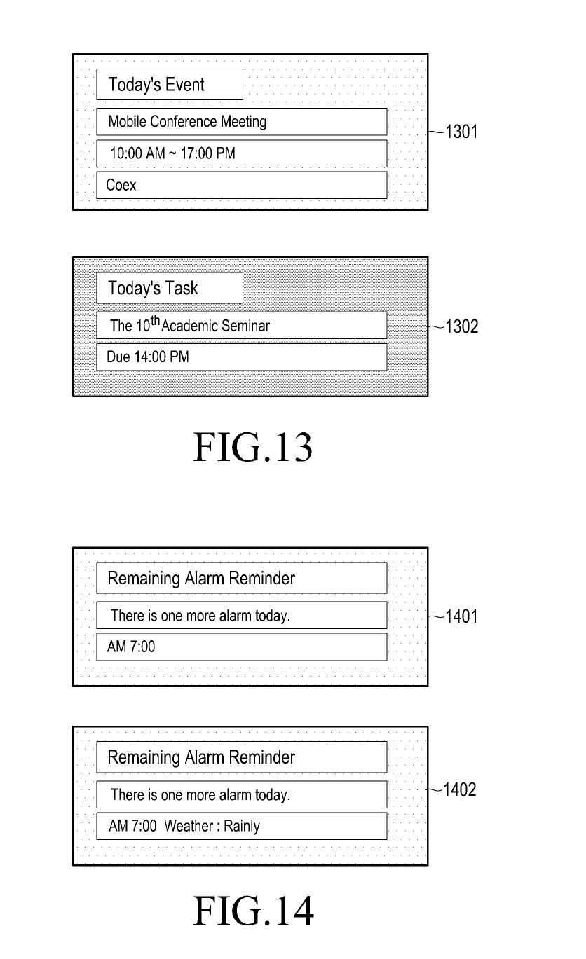

FIG. 13 illustrates a plurality of content types provided by one second application according to various embodiments of the present disclosure.

Referring to FIG. 13, one second application may provide today's event contents 1301 or today's task contents 1302 to the third application 210 at the time corresponding to time information included in the today's event contents 1301 and time information included in the today's task contents 1302. As illustrated in FIG. 13, one second application may provide a plurality of contents, such as today's event contents 1301 and today's task contents 1302 to the third application 210.

FIG. 14 illustrates one content type provided by a plurality of second applications according to various embodiments of the present disclosure.

Referring to FIG. 14, among the plurality of second applications, an event second application may provide today's event contents 1401 to the third application 210 at the time corresponding to time information included in the today's event contents 1401. Furthermore, among the plurality of second applications, a task second application may provide today's task contents 1402 to the third application 210 at the time corresponding to time information included in the today's task contents 1402. As illustrated in FIG. 14, each of the plurality of second applications may provide today's event contents 1401 and today's task contents 1402 to the third application 210.

According to various embodiments of the present disclosure, the third application 210 may control an amount or a display method of information of the contents, which are received from the first application 220, displayed to the user according to the characteristic of the third application 210 or the state of the third application 210. In general, the third application 210 may be an application (particularly, home application/launcher, lock application, background widget application, or general application) installed in the electronic device 104 in which the first application 220 is installed. Furthermore, the third application 210 may be an application, which is located outside the first application 220 and installed in the second electronic device connected to the first electronic device through a communication means.

Accordingly, the characteristic of the third application 210 may be the attribute of the application, or may be the attribute of the electronic device 104 in which the application is installed or the state of the electronic device 104. Even the same third application 210 may display different types of information to the user according to the electronic device 104 in which the third application 210 is installed. For example, an information amount by which the contents are displayed may be controlled according to a size of a display area of the application. For example, in the third application 210 executed in the electronic device 104 having a large screen, all elements included in the contents, for example, Description, title body1, body2 and the like may be displayed on one screen. However, in the third application 210 executed in the electronic device 104 having a small screen, main elements among the elements included in the contents may be displayed. Thereafter, information of the contents may be displayed to the user while other elements of the contents, which have not been displayed, are displayed according to a user input or sequentially.

According to various embodiments of the present disclosure, in spite of the same size screen, when the third application 210 is displayed on part of the screen of the electronic device, not on the entire screen by using a function, such as a widget, a popup window, a multi-screen, and the like, the third application 210 may identify a display area or position for displaying the contents and control an amount of elements of the contents displayed to the user. Furthermore, when a plurality of contents are received from a plurality of second applications or a plurality of contents are received from one second application, the third application 210 may restrictively display some elements of each of the contents to the user in order to simultaneously or sequentially display the contents received in the limited display are for displaying the contents.

According to various embodiments of the present disclosure, in order to effectively display the contents in the display area, a weighted value may be configured to each element by the first application 220 or the second application 230. For example, when it is assumed that there are text 1 of weighted value 0.3, text 2 of weighted value 0.2, and image 1 of weighted value 0.5 in the elements of the contents, if only one element among the 3 elements are to be shown, image 1 may be displayed on the display area as information of the contents in view of the weighted value.

According to various embodiments of the present disclosure, in order to effectively display the contents in the display area, an important part among the elements of the contents may be mainly displayed by the first application 220 or the second application 230. For example, in an image, when a face is configured as an important part, a cropped image in view of the display area based on a face image may be displayed in the display area as information of the contents in a whole body image.

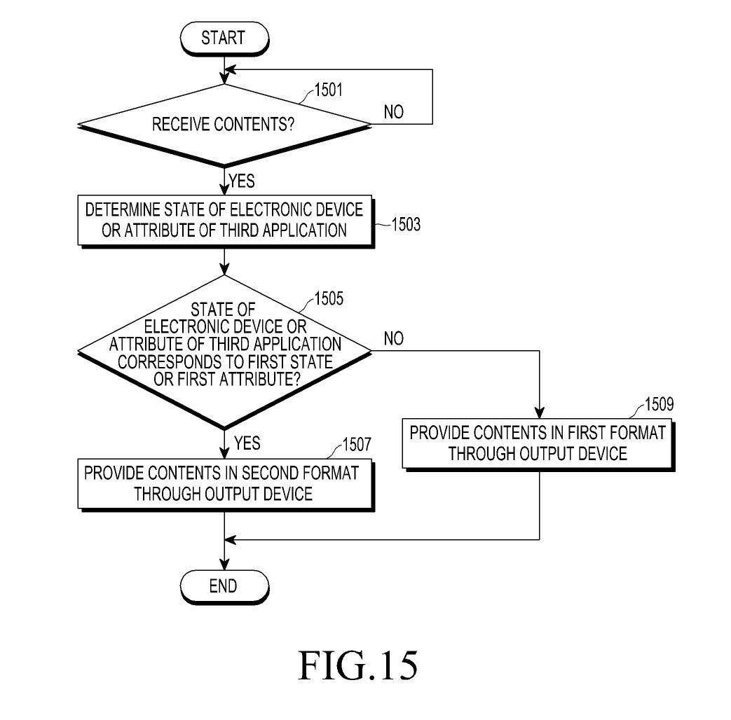

According to various embodiments of the present disclosure, the third application 210 may change a method of displaying information of the contents differently according to a state of the electronic device 104 or a situation of the user who uses the electronic device 104. For example, when it is determined from monitoring of a motion of the electronic device 104 that the user having the electronic device 104 is running or the user having the electronic device 104 is using a vehicle, the user may easily acquire information of the contents by using a method of changing a font size for displaying the information of the contents or controlling an amount of elements to be displayed among the elements of the contents. In another example, when earphones are inserted into the electronic device 104, information of the contents may be output to the user through the earphones. Furthermore, when a battery level of the electronic device 104 is equal to or lower than a threshold or when a network state of the electronic device 104 is not good, elements including text are detected from the elements of the contents and content information based on text may be displayed without displaying a video or an image. An operation in which the third application 210 provides contents will be described with reference to FIG. 15.

Furthermore, when the third application 210 provides information configured using received contents to the user, a display method and a display amount of the contents may be controlled according to the configuration by the second application 230 which generates the contents by using a security attribute, an exposure attribute, or a layer attribute configured in each element of the contents. For example, the element of the contents in which the security attribute is configured may not be directly shown to the user. The element of the contents may be processed by blank or black, authenticated, such as security settings (e.g., a password, a pattern lock, and the like) of the electronic device, and then displayed to the user. In another security attribute example, there is a method of using face authentication. When the element of the contents in which the security attribute is configured is displayed to the user, the corresponding element of the contents may be displayed after a face authentication, using a front camera installed in the electronic device 104 is performed. When another person's face other than the user is authenticated through the camera, the display may be controlled. That is, when another person is recognized together with the user through the camera unit in a state where both a different person and the user faces a screen of the electronic device, the element of the contents having the security attribute is not allowed to be displayed in the display area. In another layer attribute example, when the user is determined as a target (charged member, VIP member, or adolescent or not) that can receive advanced information at a certain level, the contents may be displayed to the corresponding user after a user authentication is performed. For example, through the authentication of the user's face recognized through the camera, it may be determined whether the user is registered as a charged member or a free member or if the user is a VIP member or a general member. Alternatively, for example, the sex or age may be determined through the authentication of the user's face recognized through the camera.

The third application 210 according to various embodiments of the present disclosure may show different information configured using the contents in two cases where the user identifies or does not identify the information. When the information configured using the contents is identified by the user, the remaining parts except for the main part, such as a title from which the user can know the existence of the information may not be displayed.

The third application 210 according to various embodiments of the present disclosure may differently display the information configured using the contents to the user according to a current display mode of the electronic device 104 displaying the information. For example, when the information is displayed on a 3D TV, the information may be displayed differently according to whether a current TV display mode is a 2D mode or a 3D mode. For example, when the current TV display mode is in 3D mode, the information may be displayed as a hologram.

FIG. 15 is a flowchart illustrating an operation in which a third application provides contents according to various embodiments of the present disclosure.

Referring to FIG. 15, when there is a determination to receive contents from the second application in operation 1501, the third application 210 may determine a state of the electronic device 104 in which the third application 210 is installed or an attribute of the third application 210 in operation 1503. The contents received in operation 1501 may include function information related to at least one of elements of the contents.

In operation 1503, the third application 210 may determine the state of the electronic device 104 or the attribute of the third application 210. When the third application 210 determines that the state of the electronic device 104 or the attribute of the third application 210 corresponds to a first state or a first attribute in operation 1505, the third application 210 may provide at least some of the received contents to the user in a first format through an output device functionally connected to the electronic device 104 in operation 1507. Alternatively, when the third application 210 determines that the state of the electronic device 104 or the attribute of the third application 210 corresponds to a second state or a second attribute in operation 1505, the third application 210 may provide at least some of the received contents to the user in a second format through the output device in operation 1509.

According to various embodiments of the present disclosure, the state of the electronic device 104 may include at least one of a bending state of the electronic device, a folding state of the electronic device, a grip state of the electronic device, a motion of the electronic device, a battery state of the electronic device, a communication state of the electronic device, a communication state between the electronic device 101 and the second electronic device 104 communicating with the electronic device 101, and a lock state of the electronic device. Accordingly, the state of the electronic device 104 may include the first state or the second state, which is different from the first state. For example, when a state where the electronic device 104 is not bent corresponds to the first state, the bending state of the electronic device 104 may be the second state. Alternatively, for example, when a state where the electronic device 104 is not folded corresponds to the first state, the folding state of the electronic device 104 may be the second state.

According to various embodiments of the present disclosure, the attribute of the third application 210 may include a size of a display area in which the contents can be displayed. According to the size of the display area, the attribute of the third application 210 may include the first attribute or the second attribute, which is different from the first attribute.

According to various embodiments of the present disclosure, the output device is a device that can provide the contents to the user, and may include at least one of a display of the electronic device 104 that can display contents, a vibration or flash for informing of the reception of contents, a communication module (for example, WiFi, BlueTooth (BT), Near Field Communication (NFC), or Global Positioning System (GPS)) that can transmit contents to the second electronic device 104 communicating with the electronic device 101.

According to various embodiments of the present disclosure, when the electronic device 104 is set in a vibration mode, the received contents correspond to schedule contents, a current state corresponds to a conference or a phone call through the schedules included in the schedule contents, the electronic device 104 is located in a closed space, such as a pocket, or a current time corresponds to a set time, for example, a late night time, the reception of the contents may be informed through the vibration.

According to various embodiments of the present disclosure, when the electronic device 104 is set in a mute mode or it the electronic device 104 is detected to be in a dark place through an illumination sensor, the reception of the contents may be informed through the flash. Furthermore, the received contents may be transmitted to and displayed in a display unit of the second electronic device, for example, a vehicle connected through the communication module, for example, BT. Alternatively, contents related to an indoor place where the electronic device 104 is located, for example, indoor guide map contents may be received or displayed through BT communication or BLE communication with a neighboring device in the indoor place where the electronic device 104 is located.

According to various embodiments of the present disclosure, the format in which the contents are provided through the output device may include a first format and a second format, which is different from the first format. Furthermore, the first format and the second format may be configured differently according to the type of output device. For example, when the contents are displayed through a display corresponding to the output device, the first format may indicate a state where all components of the received contents can be displayed and the second format may indicate a state where at least some of the components of the received contents can be displayed according to the state of the electronic device 104 or the attribute of the third application 210.

Furthermore, for example, when the reception of the contents are informed through the vibration corresponding to the output device, the vibration may be output in the first format or the second format according to a position of the electronic device 104 of information of the contents. When the electronic device 104 is not located in a closed space, such as a pocket or ambient noise is less than a threshold, the reception of the contents may be informed in the first format in which the vibration is generated with a set vibration intensity or by the number of vibrations. However, when the electronic device 104 is located in the closed space, such as the pocket or the ambient noise is greater than or equal to the threshold, the reception of the contents may be informed in the second format in which the vibration is generated in a method different from the present vibration intensity or the number of vibrations (vibration is generated with a vibration intensity which is stronger than the set vibration intensity or by the number of vibrations which is greater than the set number of vibrations). When the importance of the contents corresponds to medium or low like general mail, the reception of the contents may be informed in the first format in which the vibration is generated with the set vibration intensity or by the number of vibrations. Furthermore, when the importance of the contents corresponds to high like emergency mail, the reception of the contents may be informed in the second format in which the vibration is generated in the method different from the present vibration intensity or the number of vibrations (vibration is generated with the vibration intensity which is stronger than the set vibration intensity or by the number of vibrations which is greater than the set number of vibrations).

In addition, for example, when the contents are output through a speaker corresponding to the output device, the contents may be output through the speaker in the first format or the second format according to the state of the electronic device 104 or the information of the contents. When the state of the electronic device 104 corresponds to a state where the speaker is exposed, the contents may be provided in the first format in which the reception of the contents is informed with a set level or the information of the contents are output through the speaker. However, when the state of the electronic device 104 corresponds to a state where the speaker is hidden, for example, when the electronic device 104 is lying face down, the contents may be provided in the second format in which the reception of the contents is informed with a level greater than the set level or the information of the contents is output through the speaker. When the contents correspond to the mail, if a sender of the mail is a male, a notification sound for informing of the reception the contents or information of the contents may be output in the first format in which a male voice is output through the speaker. Alternatively, if a sender is a female, a notification sound for informing of the reception of the contents or information of the contents may be output in the second format in which a female voice is output through the speaker.

Furthermore, for example, when the reception of the contents are informed through the flash corresponding to the output device, the contents may be output through the flash in the first format or the second format according to ambient brightness of the electronic device 104 or information of the contents. When the ambient brightness of the electronic device 104 is greater than or equal to a threshold, the reception of the contents may be informed in the first format in which the flash is operated with a reduced flash brightness level. However, when the ambient brightness of the electronic device 104 is less than the threshold, the reception of the contents may be informed in the second format in which the flash is operated with an increased flash brightness level. When the importance of the contents corresponds to medium or low like a general mail, the reception of the contents may be informed in the first format in which a first color LED, for example, a green LED is output. Furthermore, the importance of the contents corresponds to high like an emergency mail, the reception of the contents may be informed in the second format in which a second color LED, for example, a red LED is output.

In addition, for example, when the contents are displayed through the communication module corresponding to the output device, if the communication module, for example, BT, GPS, or WiFi is turned on, the position of the electronic device 104 is detected using the communication module and information contents about the location of the electronic device 104 may be provided to the electronic device 104 in the first format or the second format according to the type of information contents about the location. When communication between the electronic device 104 and the second electronic device, for example, an arm band is connected while particular contents, for example, health contents are provided through the display of the electronic device 104 in the first format, the contents may be provided to the second electronic device 104 in the second format in which the health contents can be displayed on the display of the second electronic device.

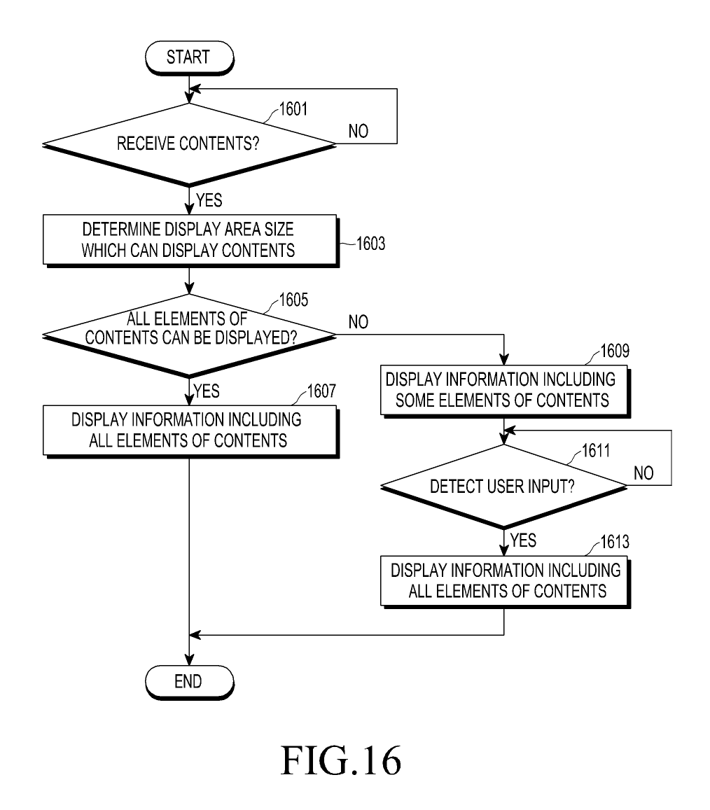

Embodiments of providing various contents according to a state of the electronic device 104 or an attribute of the third application 210 will be described through FIGS. 16 to 32.

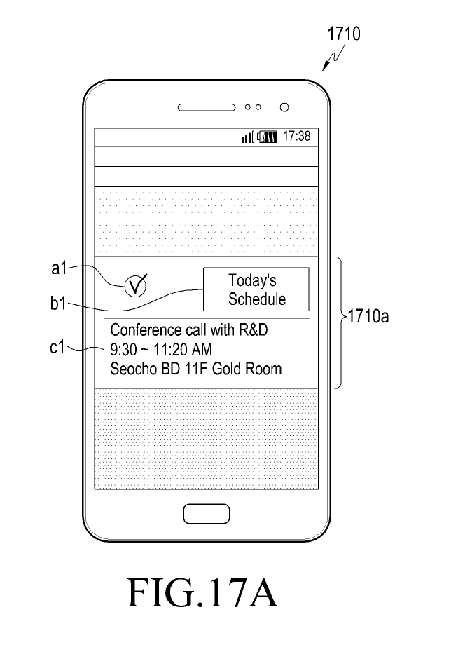

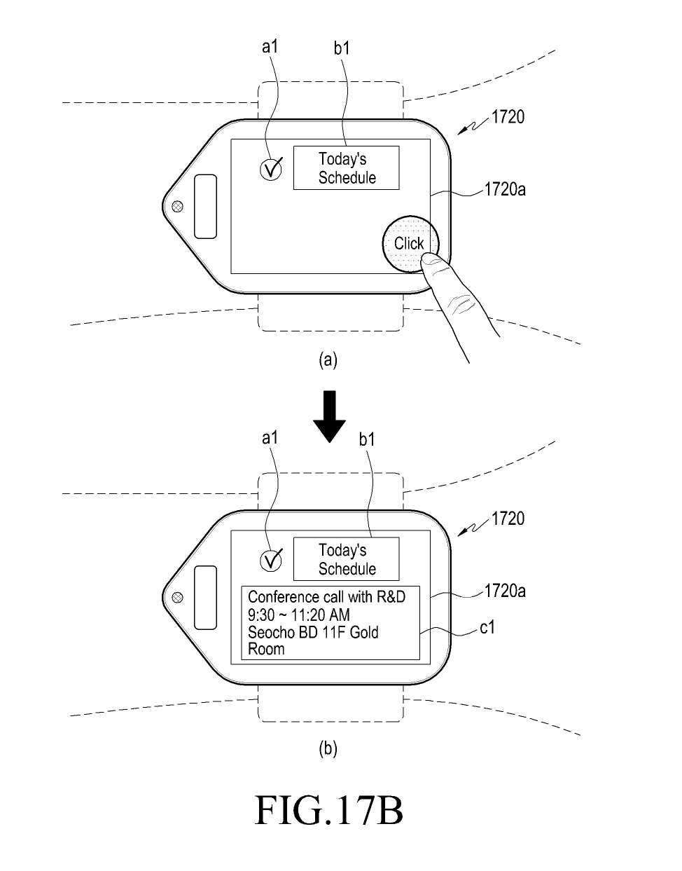

FIG. 16 is a flowchart illustrating an operation of displaying contents according to a display of an electronic device according to various embodiments of the present disclosure and FIGS. 17A and 17B illustrate an operation of displaying contents according to a display of an electronic device according to various embodiment of the present disclosure.

Referring to FIG. 16, when contents are received from the first application 220 in operation 1601, the third application 210 may determine a size of a display area in the screen of the electronic device 101 in which the contents can be displayed in operation 1603.

When the size of the display area is determined as a size big enough to display all elements of the received contents in operation 1605, information including all elements of the contents may be displayed in the display area in operation 1607. When the size of the display area is determined as a size that cannot display all elements of the received contents in operation 1605, information including some elements of the contents may be displayed in the display area in operation 1609. When an input by the user is detected in a particular part of the display area in operation 1611, the third application 210 may display information including all elements of the contents in the display area in operation 1613.

The operation of FIG. 16 will be described through FIGS. 7A and 7B.

Referring to FIG. 7A, a first electronic device 1710 having a large display area 1710a displays icon a1 indicating a content type, description information b1 indicating today's schedule information, and body information c1 indicating date and time/place/detail content.

However, referring to FIG. 17B (a), a second electronic device 1720 having a small display area 1720a may first display information including icon a1 indicating a content type and description information b1 indicating today's schedule information. Thereafter, when an input (click) by the user is generated, information including icon a1, description information b1 indicating the today's schedule information, and the body information c1 indicating the data and time/place/detail content may be displayed as illustrated in FIG. 17B.

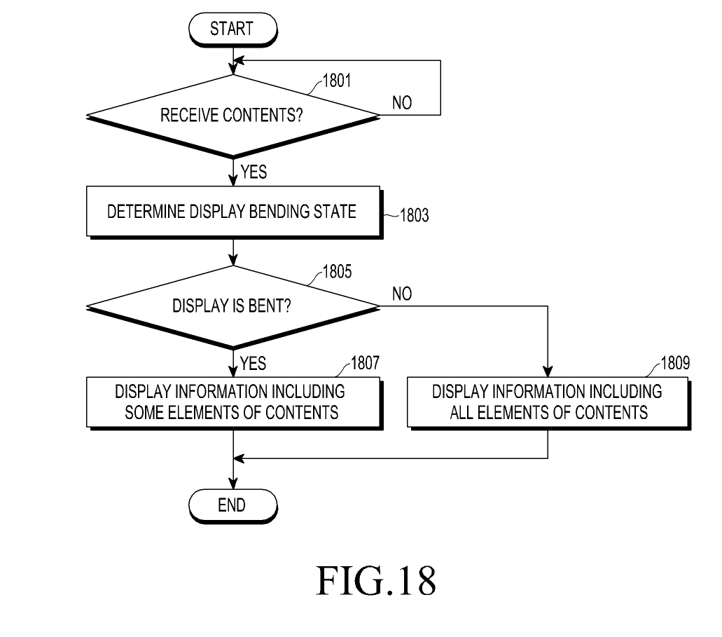

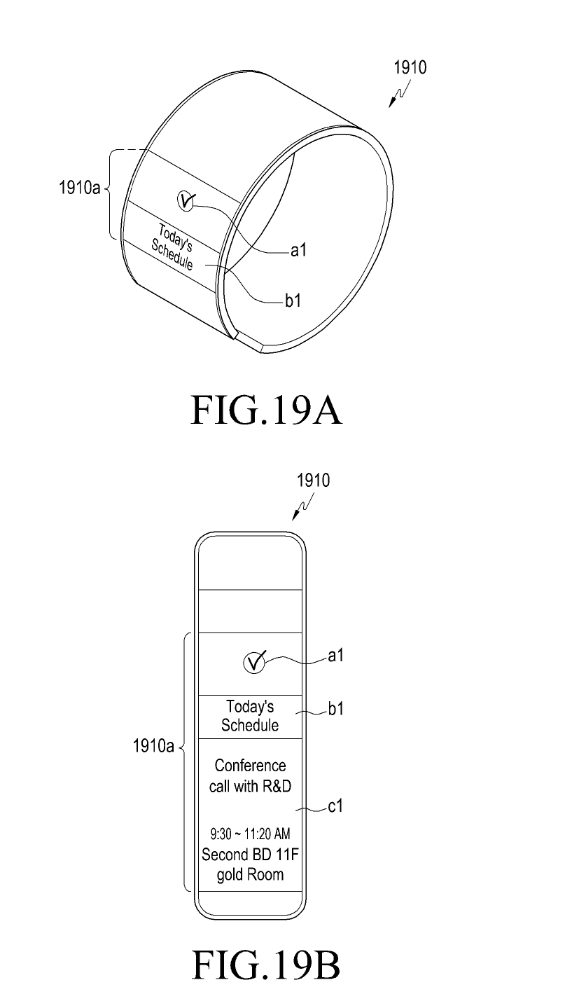

FIG. 18 is a flowchart illustrating an operation in which an electronic device displays contents according to a display bending state of the electronic device according to various embodiments of the present disclosure and FIGS. 19A and 19B illustrate an operation in which an electronic device displays contents according to a display bending state of the electronic device according to various embodiment of the present disclosure.

Referring to FIG. 18, when contents are received from the first application 220 in operation 1801, the third application 210 may determine a bending state of a display area in which the contents can be displayed according to a bending state of the electronic device 101 including to a bendable display in operation 1803.

When the state of the display area is determined as the bending state in operation 1805, the third application 210 may display information including some elements of the contents in the display area in operation 1807. When the state of the display area is not determined as the bending state in operation 1805, the third application 210 may display information including all elements of the contents in the display area in operation 1809.

The operation of FIG. 18 will be described through FIGS. 19A and 19B. As illustrated in FIG. 19A, when a display area 1910a for displaying the contents according to a bending state of the electronic device 1910 is in the bending state, information including icon a1 indicating the content type and description information b1 indicating the today's schedule information may be displayed. Furthermore, as illustrated in FIG. 19B, the display area 1910 which is not bent as the electronic device 1910 is not in the bending state, may display information including icon a1, description information b1 indicating today's schedule information, and body information c1 indicating date and time/place/detail content.

In other words, FIGS. 19A and 19B describe an operation of determining state information corresponding to the bending of the display area and varying the form of showing contents. Furthermore, through the detection of a change in the bending of the display area, the contents may be automatically changed and displayed from FIG. 19A to FIG. 19B or from FIG. 19B to FIG. 19A.

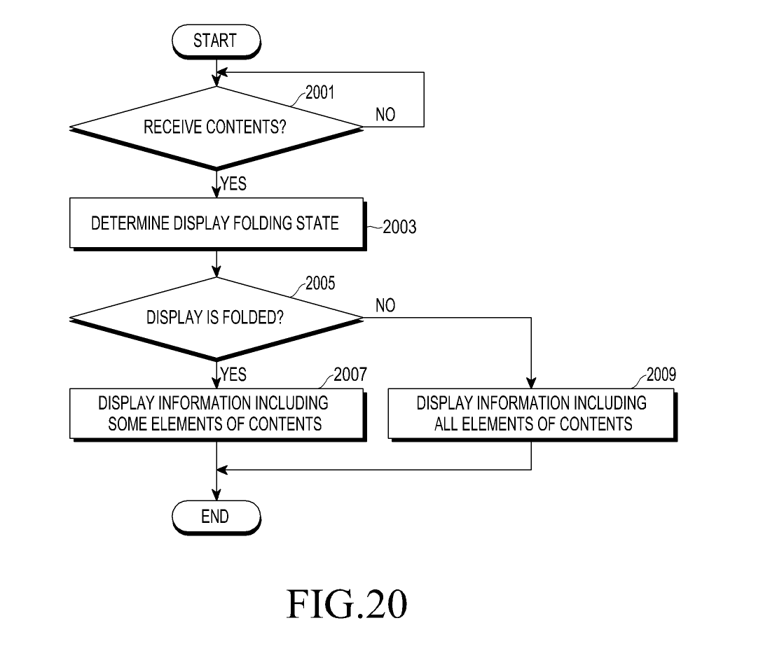

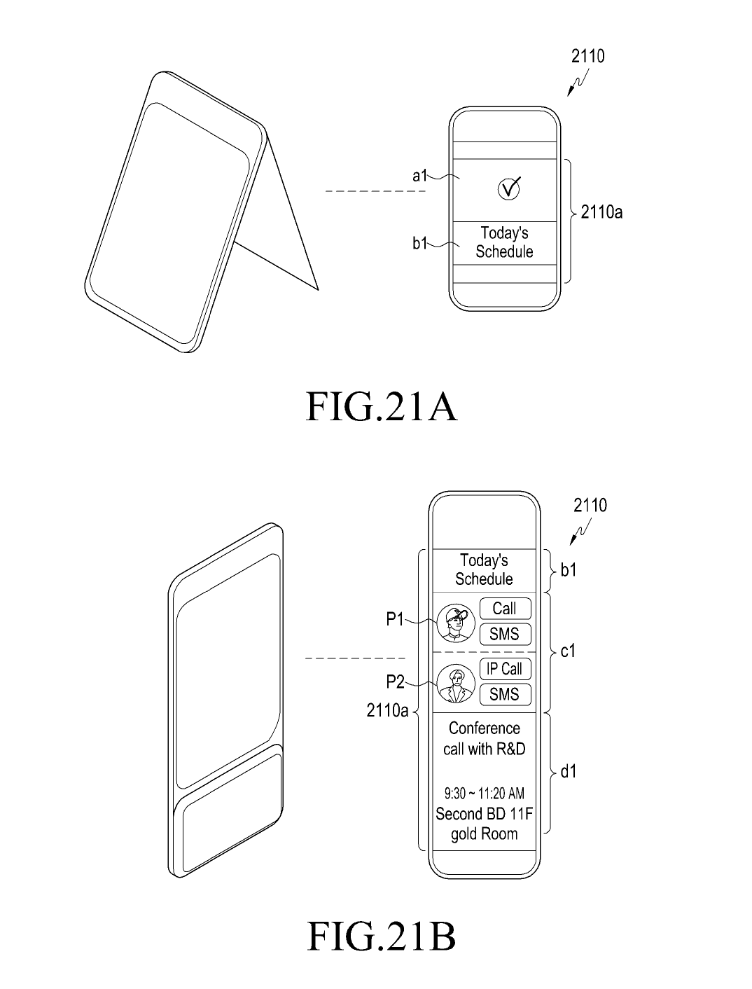

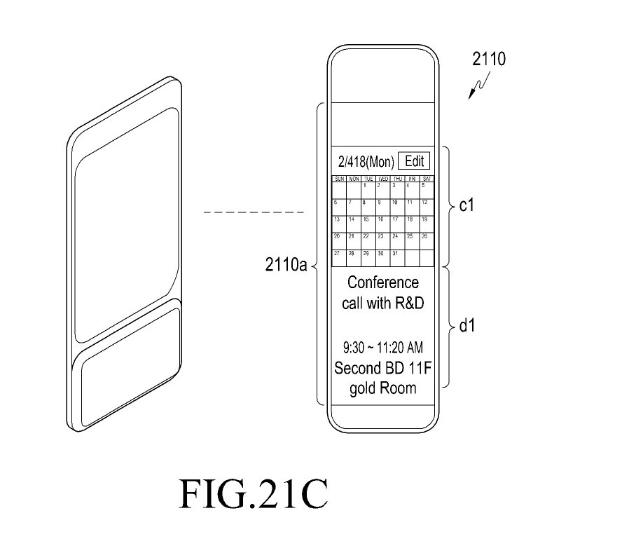

FIG. 20 is a flowchart illustrating an operation in which an electronic device displays contents according to a display folding state of the electronic device according to various embodiments of the present disclosure and FIGS. 21A, 21B, and 21C illustrate an operation in which an electronic device displays contents according to a display folding state of the electronic device according to various embodiment of the present disclosure.

Referring to FIG. 20, when contents are received from the first application 220 in operation 2001, the third application 210 may determine a folding state of a display area in which the contents can be displayed according to a folding state of the electronic device including to a foldable display in operation 2003.

When the state of the display area is determined as the folding state in operation 2005, the third application 210 may display information including some elements of the contents in the display area in operation 2007. When the state of the display area is not determined as the folding state in operation 2005, the third application 210 may display information including all elements of the contents in the display area in operation 2009.

The operation of FIG. 20 will be described through FIGS. 21A, 21B, and 21C.

Referring to FIG. 21A, when a display area 2110a is partially folded according to a folding state of the electronic device 2110, information including icon a1 indicating the content type and description information b1 indicating the today's schedule information may be displayed.

Furthermore, referring to FIG. 21B, as the electronic device 2110 is not folded or the electronic device 2110 is folded and then unfolded, if the display area 2110a for displaying the contents are not folded, the display area 2110a may display all elements included in today's schedule contents. The display area 2110a may display information including description information b1 indicating today's scheduling information, body information c1 displaying types of communication means in which function information is configured to allow participants of the schedule to perform a communication function, and body information d1 indicating date and time/place/detail content of the today's schedule information. The types of communication means belonging to the participants may be generated with reference to pre-stored today's schedule content information. With respect to the types of communication means belonging to the participants, communication means having a good communication state may be displayed with reference to past communication histories with the participants or a current communication network access state. That is, by displaying Call and SMS as a communication means of first participant P1 in body information c1, a display indicating that communication with first participant P1 can be performed through Call or SMS is currently made. Further, by displaying IP Call and SMS as a communication means of second participant P2 in body information c1, a display indicating that communication with second participant P2 can be performed through IP Call or SMS is currently made. A method of determining whether the communication mean is IP Call or Call may include at least one of an operation of identifying whether the first electronic device of the user accesses a Wi-Fi network and an operation of identifying whether the second electronic device of a counterpart to communicate with the first electronic device accesses the Wi-Fi network.

Furthermore, referring to FIG. 21C, if the display area 2110 for displaying the contents are not in the folding state as the electronic device 2110 is folded and then unfolded, the display area 2110a may display information including content elements, which is different from the information including the content elements displayed in the display area 2110a when the electronic device 2110 is in the folding state. In FIG. 21C, the display area 2110a may display information including boy c1 indicating a calendar in regard to today's schedule contents and body information d1 indicating date and time/place/detail content of today's schedule information. In the calendar displayed in body c1, today's date is distinguished from other dates. Whenever the user selects another date by using the calendar, schedule information configured in the selected date may be displayed in body information d1. Furthermore, an edit button may be provided to body c1 as function information that can edit schedule configured based on each date. In other words, FIGS. 21A, 21B, and 21C describe an operation of determining state information corresponding to the folding of the display area and varying the form of showing contents. Furthermore, through the detection of a change in the folding of the display area, the contents may be automatically changed and displayed from FIG. 21A to FIG. 21B or FIG. 21C or from FIG. 21B or FIG. 21C to FIG. 21A.

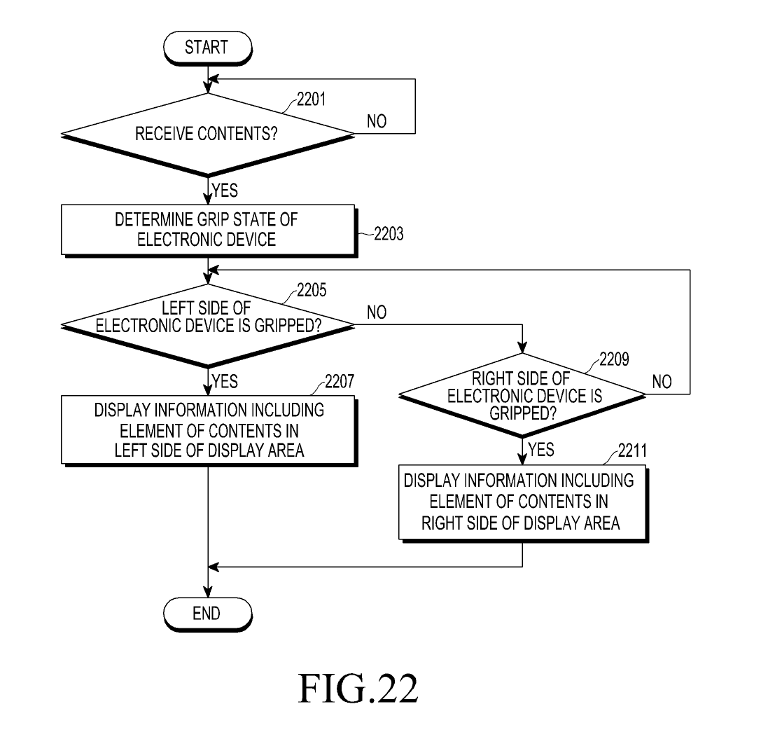

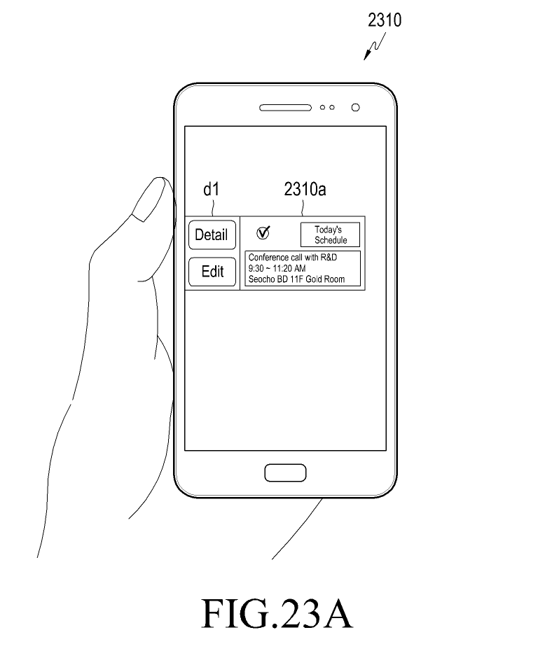

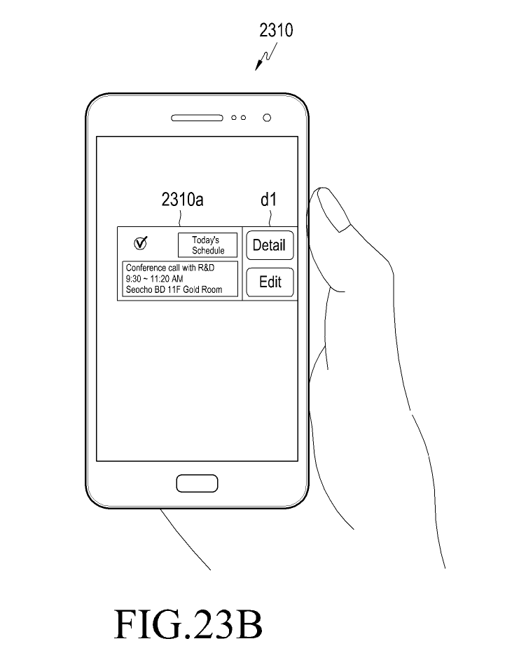

FIG. 22 is a flowchart illustrating an operation in which an electronic device displays contents according to a grip state of the electronic device according to various embodiments of the present disclosure and FIGS. 23A and 23B illustrate an operation in which an electronic device displays contents according to a grip state of the electronic device according to various embodiment of the present disclosure.

Referring to FIG. 22, when the contents are received from the first application 220 in operation 2201, the third application 210 may determine a grip state of the electronic device 101 in operation 2203.

When a left grip of the electronic device 101 is detected in operation 2205, the third application 210 may display information including elements of the contents in a left side of the display area in operation 2207. When a right grip of the electronic device 101 is detected in operation 2209, the third application 210 may display information including elements of the contents in a right side of the display area in operation 2211.

The operation of FIG. 22 will be described through FIG. 23.

Referring to FIG. 23A, when the left side of the electronic device 101 is gripped with the left hand of the user, information including the elements of the contents may be displayed on the left side of the display area 2310a, so that the user can conveniently select the contents by using a user's left thumb. In this case, among the elements of the contents, element d1 having function information may be located in the most left side and thus easily selected by the user.

Furthermore, referring to FIG. 23B, when the right side of the electronic device 2310 is gripped by the right hand of the user, information including elements of the contents may be displayed on the right side of the display area 2310, so that the user can conveniently select the contents by using a user's right thumb. In this case, among the elements of the contents, element d1 having function information may be located in the most right side and thus be easily selected by the user.

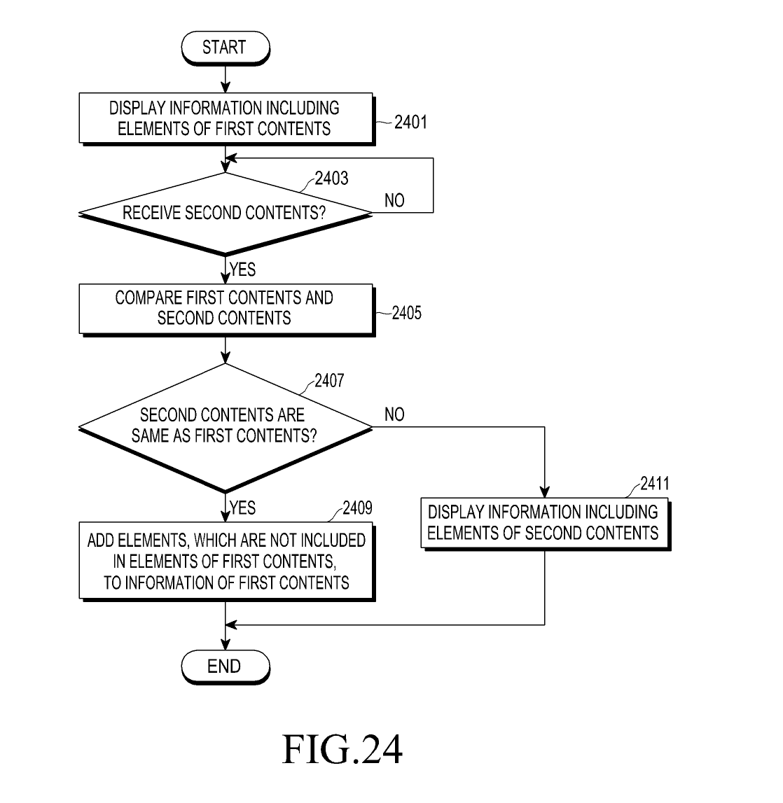

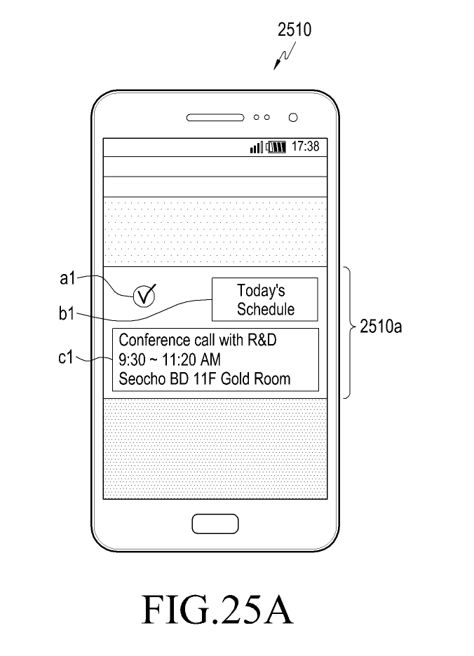

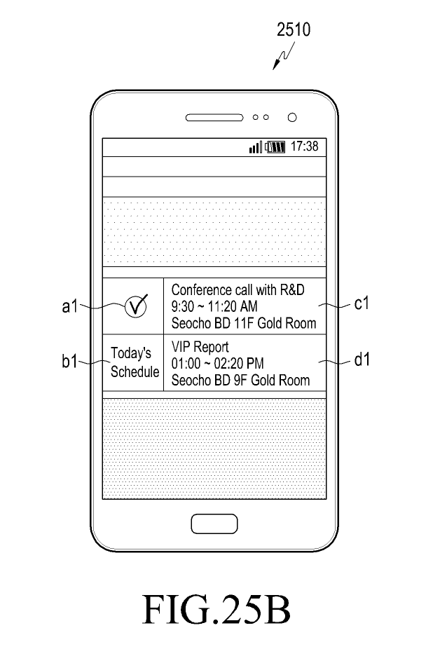

FIG. 24 is a flowchart illustrating an operation in which an electronic device displays same contents according to various embodiments of the present disclosure and FIGS. 25A and 25B illustrate an operation in which an electronic device displays same contents according to various embodiment of the present disclosure.

Referring to FIG. 24, when second contents are received from the first application 220 in operation 2403 while information including elements of first contents is displayed in a display area in operation 2401, the third application 210 compares the first contents and the second contents in operation 2405.

When the third application 210 determines that the first contents and the second contents are the same type contents in operation 2407, the third application 210 may add elements that are not included in the elements of the first contents among the elements of the second contents to information of the first contents and display the information of the contents in operation 2409. When the third application 210 determines that the first contents and the second contents are different type contents in operation 2407, the third application 210 may display information including the elements of the second contents in the corresponding display area in operation 2411.

The operation of FIG. 24 will be described through FIGS. 25A and 25B.

Referring to FIG. 25A, a display area 2510a of an electronic device 2510 displays icon a1, description information b1 indicating today's schedule information, and body information c1 indicating date and time/place/detail content, which are elements of the first contents. When the second contents, which are the same type contents as the first contents are received while information of the first contents is displayed as illustrated in FIG. 25A, the third application 210 may add additional element d1, which is not included in the elements of the first contents among the elements of the second contents to the information of the first contents and display the information of the first contents without generating new information by using the elements of the second contents as illustrated in FIG. 25B.

Referring to FIG. 25B, arrangements of icon a1, description information b1 indicating today's schedule information, and body information c1 indicating date and time/place/detail content which are the elements of the first contents, and additional element d1 which is not included in the elements of the first contents may be changed and displayed.

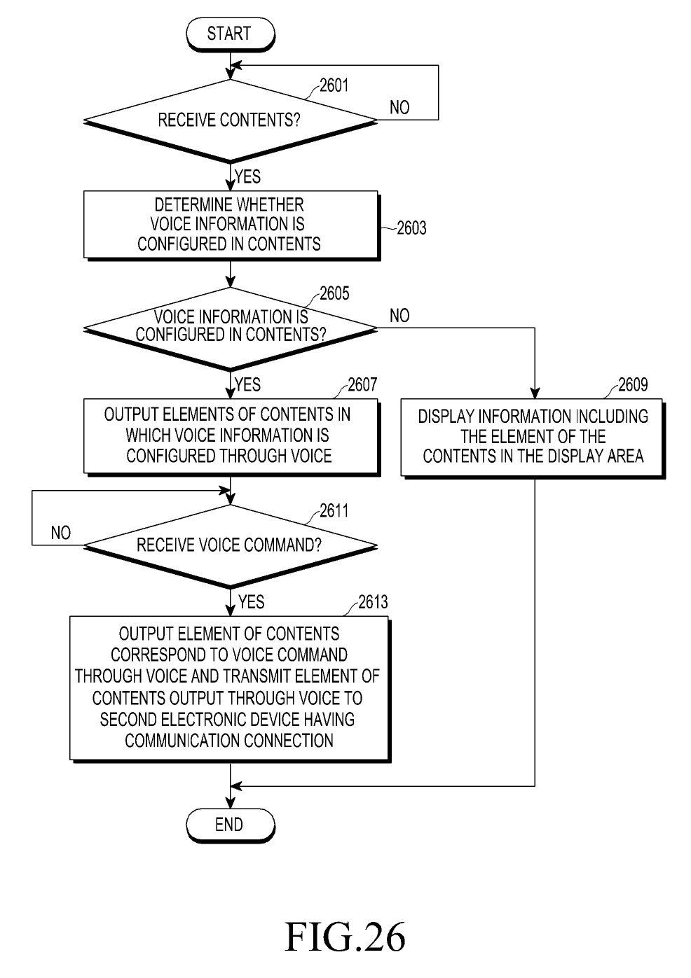

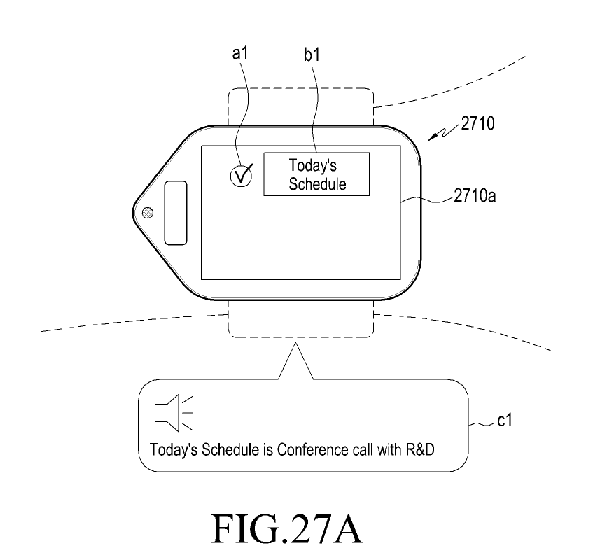

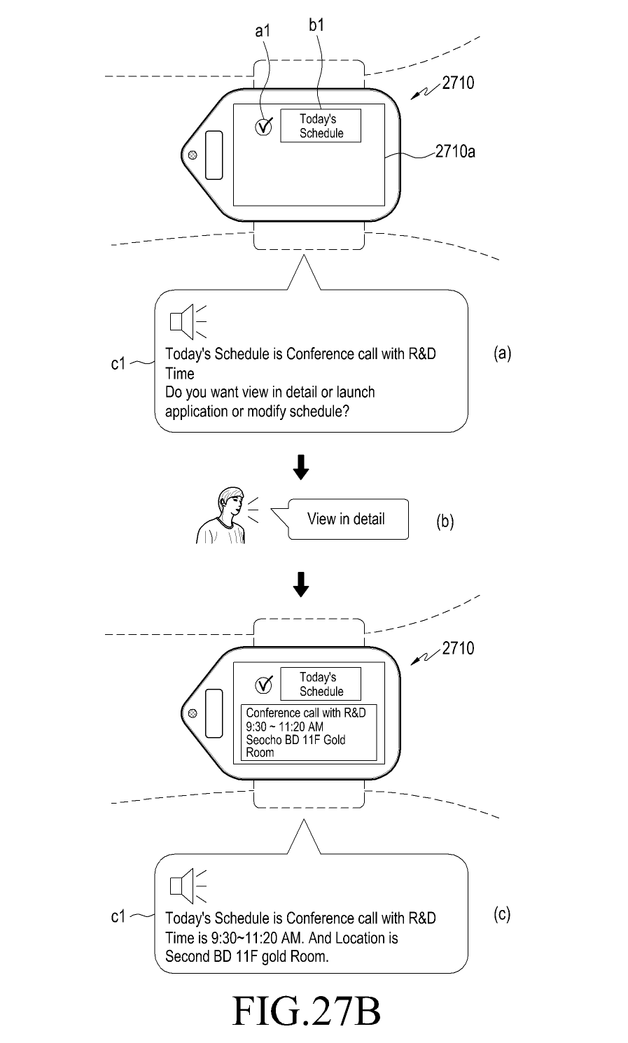

FIG. 26 is a flowchart illustrating an operation in which an electronic device outputs contents through a voice according to various embodiments of the present disclosure and FIGS. 27A and 27B illustrate an operation in which an electronic device outputs contents through a voice according to various embodiment of the present disclosure.

Referring to FIG. 26, when the contents are received from the first application 220 in operation 2601, the third application 210 may determine whether there is an element having voice information in the elements of the received contents in operation 2603.

When the element having the voice information is not detected from the elements of the contents in operation 2605, the third application 210 may display information including the elements of the contents in the corresponding display area in operation 2609. When the element having the voice information is detected from the elements of the contents in operation 2605, the third application 210 may output the substance of the element, in which voice information is configured, among the elements of the contents through a voice in operation 2607.

When a voice command is received in operation 2611, the third application 210 may output the substance of the element corresponding to the voice command among the elements of the contents through a voice in operation 2613. In operation 2611, the third application 210 may transmit the substance of the components of the contents output through a voice to a second electronic device communicating with the electronic device and the second electronic device may output the substance.

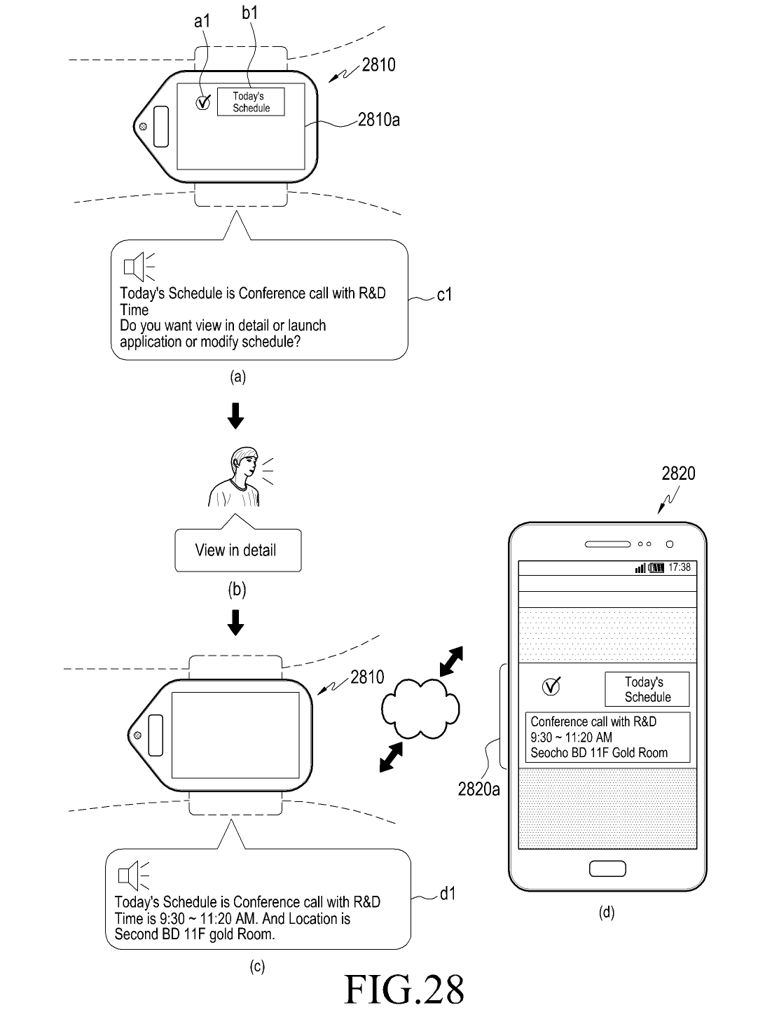

The operation of FIG. 26 will be described through FIGS. 27A and 27B and FIG. 28. As illustrated in FIG. 27A, while information including icon a1 and description information b1 indicating today's schedule information, which are elements of the contents is displayed in a display area 2710a of a first electronic device 2710, date and time/place/detail content of body information c1 having voice information among the elements of the contents may be output as a voice. The substance of the element output through the voice may be defined in metadata of the contents through a specific tag.

Furthermore, referring to FIG. 27B (a), a voice command (“View in Detail”) may be received while information including icon a1 of the content elements and description information b1 indicating today's schedule information is displayed in the display area 2710a and date and time/place/detail content of body c1 is displayed through a voice. When the voice command (“View in Detail”) is received as illustrated in FIG. 27B (b), substance d1 of the element corresponding to the voice command among the content elements may be output through a voice as illustrated in FIG. 27B (c).

Referring to FIG. 27B, a method of outputting contents through a voice and controlling function information included in the contents through a voice is described. For example, information on registered contents may be provided through a voice and guide of function information may be provided through a voice. For example, text information of today's schedule may be read through a voice. Thereafter, the user may ask about desired function information through a voice command. In FIG. 27B (b), the substance of today's schedule of the user is described and “view in detail”, “Launch application”, or “Modify or schedule” may be guided to the user through a voice. Thereafter, when the user speaks a voice command, such as “view in detail”, the user may view the specific substance of today's schedule through the electronic device 2710.

Furthermore, a voice command (“View in Detail”) may be received as illustrated in FIG. 28 (b) while information including icon a1 of the content elements and description information b1 indicating today's schedule information is displayed in the display area 2810a and date and time/place/detail content of body c1 is displayed through a voice as illustrated in FIG. 28 (a). When the voice command (“View in Detail”) is received as illustrated in FIG. 28 (b), substance d1 of the element corresponding to the voice command among the content elements may be output through a voice as illustrated in FIG. 28 (c).

Furthermore, as illustrated in FIG. 28 (d), substance d1 of the element corresponding to the voice command output through the voice is transmitted to a second electronic device 2820 communicating with a first electronic device 2810, and thus the transmitted substance may be displayed in a display area 2820a of the second electronic device 2820. The first electronic device 2810 may be switched to a sleep mode while substance d1 of the element corresponding to the voice command is displayed in the display area 2820a of the second electronic device 2820.

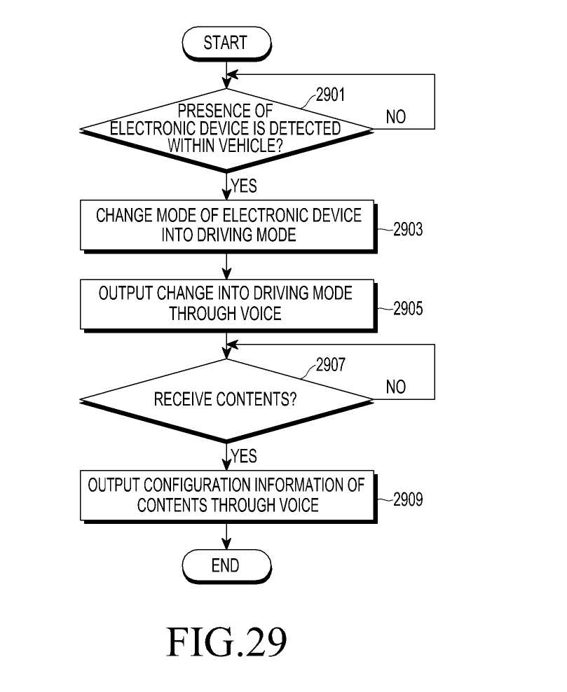

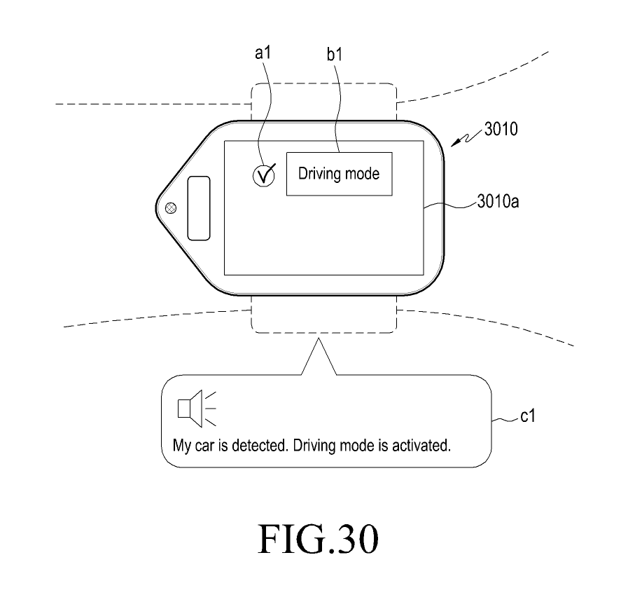

FIG. 29 is a flowchart illustrating an operation in which an electronic device outputs contents through a voice according to a position of the electronic device according to various embodiments of the present disclosure and FIG. 30 illustrates an operation in which an electronic device outputs contents through a voice according to a position of the electronic device according to various embodiments of the present disclosure.

Referring to FIG. 29, when it is determined that an electronic device is located within a car through a communication module, for example, BT or GPS in operation 2901, the third application 210 may change a mode of the electronic device into a driving mode in operation 2903. When the mode of the electronic device is changed into the driving mode, the third application 210 may output the change of the electronic device into the driving mode in operation 2905. When contents are received from the first application 220 in operation 2907 in a state where the mode of the electronic device is changed into the driving mode, the third application 210 may output elements of the contents through a voice in operation 2909.

Referring to FIG. 30, when the mode of an electronic device 3010 is changed into a driving mode, a display area 3010a of the electronic device 3010 may display icon a1 indicating the driving mode and text b1 indicating the driving mode and output substance c1 indicating that the electronic device 201 is located within a car and the mode of the electronic device is changed into the driving mode through a voice.

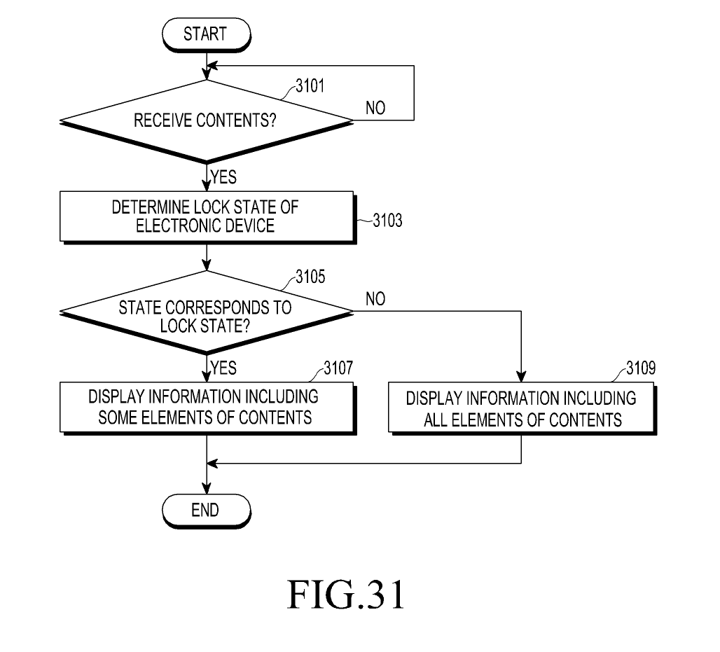

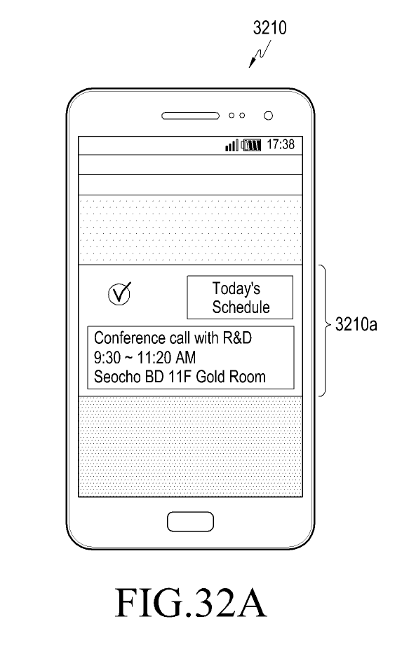

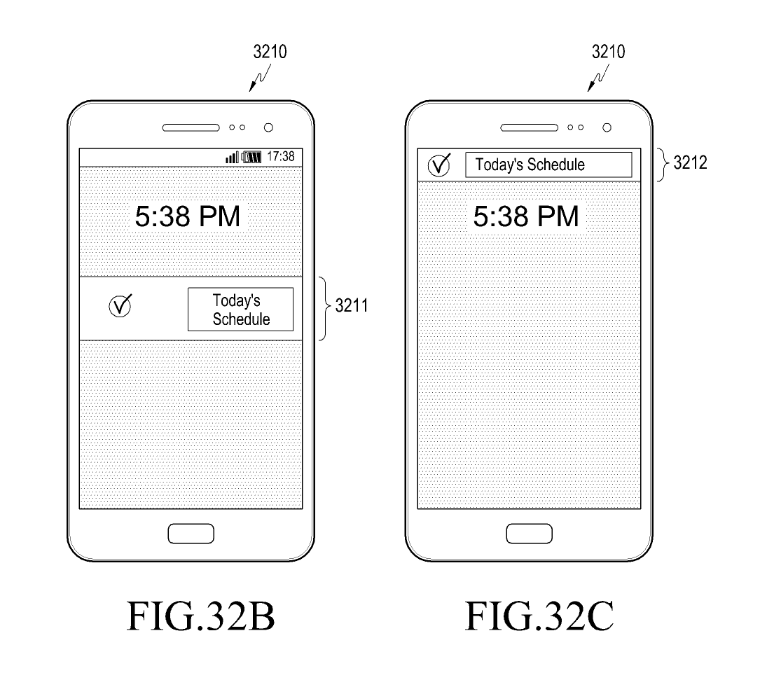

FIG. 31 is a flowchart illustrating an operation in which an electronic device displays contents according to a lock state of the electronic device according to various embodiments of the present disclosure and FIG. 32 illustrate an operation in which an electronic device displays contents according to a lock state of the electronic device according to various embodiments of the present disclosure.

Referring to FIG. 31, when contents are received from the first application 220 in operation 3101, the third application 210 may determine a lock state of the electronic device in operation 3103. When the electronic device is determined as being in the lock state in operation 3105, the third application 210 may display information including some of the elements of the received contents in a display area in operation 3107. When the electronic device is determined as being in an unlocked state in operation 3105, the third application 210 may display information including all the elements of the received contents in the display area in operation 3109.

The operation of FIG. 31 will be described through FIGS. 32A, 32B, and 32C.

Referring to FIG. 32A, when an electronic device 3210 is in a lock state, information including elements of the contents may be displayed in a display area 3210a.

Furthermore, referring to FIGS. 32B and 32C, when the electronic device 3210 is in an unlocked state, information including icon a1 corresponding to the element of the contents and description information b1 indicating today's schedule information may be displayed in certain areas 3211 and 3212 of a lock screen of the electronic device 3210.

According to various embodiments of the present disclosure, the third application 210 may receive contents having function information configured in at least one element among the elements of the contents from the first application 220. The function information defines a function linked with the contents and corresponds to a part defining user interaction for the contents. A method in which the contents are linked with the function information may be determined by the third application 210 according to a characteristic/setting of the third application 210 or a characteristic of the electronic device having the third application 210 installed therein.

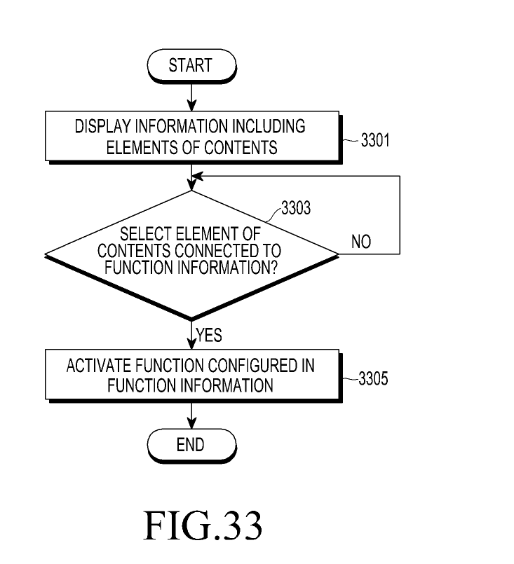

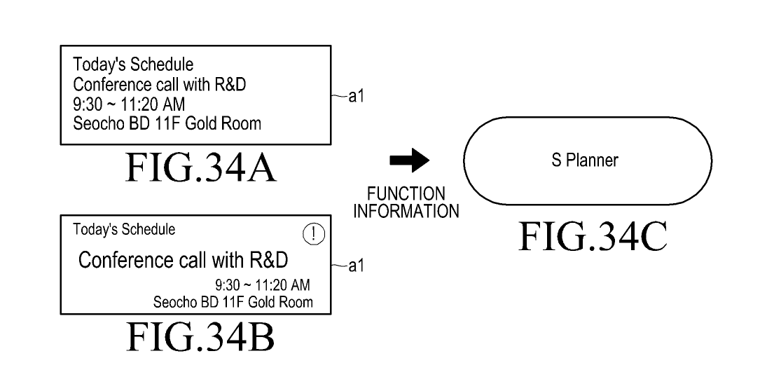

FIG. 33 is a flowchart illustrating an operation in which an electronic device executes function information of contents according to various embodiments of the present disclosure, and FIGS. 34A, 34B, and 34C illustrate an operation of executing function information of contents in an electronic device according to various embodiments of the present disclosure.

Referring to FIG. 33, in operation 3301, the third application 210 may display information including configuration information of contents received from the first application 220. When configuration information to which the function information is connected is selected while the information is displayed in operation 3303, a function configured in the function information may be activated in operation 3305.

The operation of FIG. 33 will be described through FIGS. 34A, 34B, and 34C.

Referring to FIGS. 34A, 34B, and 34C, when time element (9:30-11:20 AM) a1 is selected by the user while information (a) or information (b) including elements of the contents is displayed in a display area, an S planner application configured in time element (9:30-11:20 AM) a1 as function information may be activated.

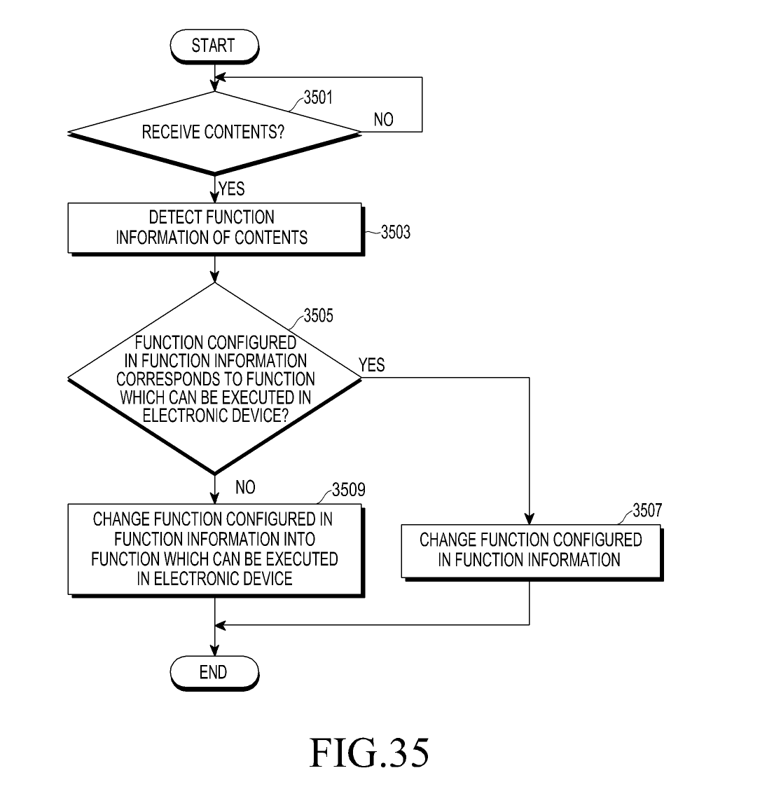

FIG. 35 is a flowchart illustrating an operation in which an electronic device changes function information of contents according to various embodiments of the present disclosure.

Referring to FIG. 35, when the contents are received from the first application 220 in operation 3501, the third application 210 may detect function information configured in at least one of the elements of the contents in operation 3503.

Furthermore, in operation 3505, the third application 210 may determine whether the function information configured in the contents is a function that can be activated in the electronic device. When it is determined that the function information configured in the contents is the function that can be activated in the electronic device in operation 3505, the third application 210 may display information including the elements of the contents in operation 3507. When it is determined that the function information configured in the contents is a function that cannot be activated in the electronic device in operation 3505, the third application 210 may change the function information into a function related to the contents among functions of the electronic device and reconfigure the function in operation 3509.

For example, while the electronic device having a touch screen displays information including the elements of the contents, the electronic device may activate a function configured in the function information by selecting the element in which the function information is configured. However, when the electronic device that does not have a touch screen receives the contents, the electronic device may change a trigger point of the corresponding function information. For example, by making a number in each of the elements of the contents displayed in the display area while information including the elements of the contents is displayed in the display area, the user may select the number by using a remote control to active function information on the corresponding element. For example, when contents in which a “function of making a phone call” is configured as function information are received by a WiFi-only electronic device having no call function, the function information configured as the corresponding function of making a phone call cannot be performed. When the contents in which a call function is configured as function information, the third application 210 installed in the WiFi-only electronic device may change the function information configured as the call function into another function, for example, an Instant Message (IM) function which can be executed by the WiFi-only electronic device or activate a defined voice over Internet protocol (VoIP) application (for example, viper or voice chart).

As described above, the third application 210 may change the function information configured in the contents or re-configure the definition of the function information.

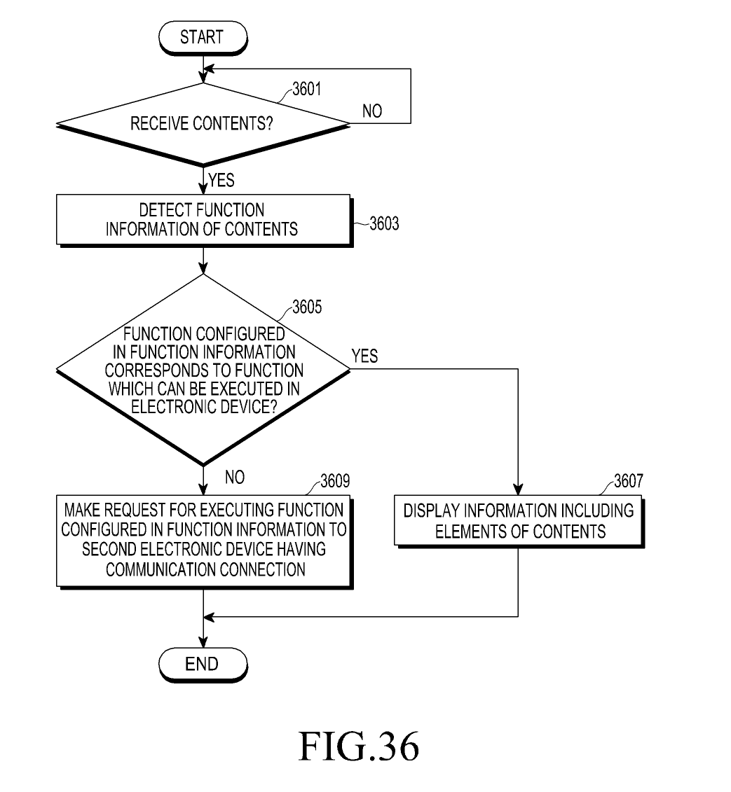

FIG. 36 is a flowchart illustrating an operation of performing function information of contents of an electronic device in another electronic device according to various embodiments of the present disclosure.

Referring to FIG. 36, when the contents are received from the first application 220 in operation 3601, the third application 210 may detect function information configured in at least one of the elements of the contents in operation 3603. Furthermore, in operation 3605, the third application 210 may determine whether the function information configured in the contents is a function that can be activated in the electronic device.

When it is determined that the function information configured in the contents is the function that can be activated in the electronic device in operation 3605, the third application 210 may display information including the elements of the contents in operation 3607. When it is determined that the function information configured in the contents is a function that cannot be activated in the electronic device in operation 3605, the electronic device may make a request for performing a function configured in the function information to a second electronic device communicating with the electronic device in operation 3609.

For example, when a full browsing function operation is requested to be performed in the second electronic device that does not support the full browsing, for example, a smart watch, the second electronic device may make a request for the full browsing function to a first electronic device that can perform the function, for example, another electronic device, such as a smart pad, a smart phone, and the like. At this time, the second electronic device (i.e., a smart watch) may display information on the first electronic device that has transmitted the full browsing function. The electronic device transmitting the request for operating the function information may be set by a user setting, or may be automatically selected by the electronic device according to a user's use pattern or a characteristic of a connected electronic device.

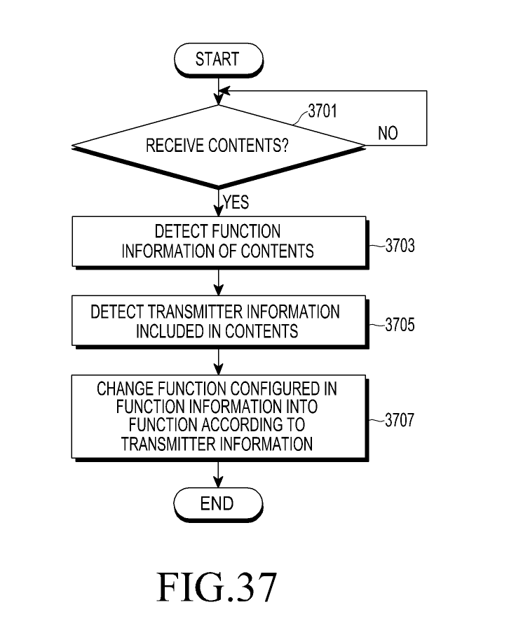

FIG. 37 is a flowchart illustrating an operation in which an electronic device changes function information of contents based on a substance of the contents according to various embodiments of the present disclosure.

Referring to FIG. 37, when the contents are received from the first application 220 in operation 3701, the third application 210 may detect function information configured in at least one of the elements of the contents in operation 3703. Furthermore, the third application 210 may detect information on a transmitter (sender) having made the contents from the contents in operation 3705. In operation 3707, the third application 210 may change function information configured in the contents into a function according to the transmitter information and configure the function.

According to various embodiments of the present disclosure, function information, such as a function of making a phone call, may be selected based on past history between a receiver who receives the call and a user. The counterpart who has made communication with the user may be analyzed based on the call history with past counterpart phone numbers. In the analysis, an important reference point may be a time. However, when the analysis is made based on the time, it is determined whether a particular counterpart is an important counterpart to me through a weighted value based on various elements related to a communication channel. That is, the importance of the communication channel may be different depending on a communication pattern used between the user and each counterpart within the communication channel. For example, when it is assumed that the user communicates ten times with counterpart 1 during a particular period through an email and the user makes a phone call two times with counterpart 2, if function information configured in the contents is a function of making a phone call, the user may activate an email application for counterpart 1 and perform a function of connecting a voice call for counterpart 2.

According to various embodiments of the present disclosure, a communication means may be connected using current presence information of the counterpart. For example, when function information configured in the contents is a function of making a phone call, if current presence information of the counterpart corresponds to conference, the user may activate an SMS or messenger function instead of the function of making a phone call. Alternatively, when the current presence information of the counterpart corresponds to a general state, a voice call may be connected. A method of knowing current information of the counterpart before the communication connection with the counterpart may use a Rich Communication Suite (RCS) technique. When the RCS technique is used, a state of the counterpart may be identified using an IP communication network.

According to various embodiments of the present disclosure, the function information may activate at least one function related to the contents among various functions provided by the first electronic device, which receives the contents or the second electronic device communicating with the first electronic device. For example, a function of activating a schedule application or making a phone call may be configured, as the function information, in the first electronic device having various applications and a phone call function and including a large screen. Alternatively, for example, when the second electronic device corresponding to a wearable electronic device having a small screen receives contents, a display area of the second electronic device may display an icon indicating a content type and description information indicating content information, and body information indicating detail information of the contents may be displayed in the first electronic device connected to the second electronic device. Alternatively, for example, in a state where the first electronic device and the second electronic device are connected to each other, when airplane takeoff time approaches and thus the first electronic device receives airplane mode on contents and then an airplane mode is turned on, the second electronic device may be also in the airplane on mode. Furthermore, when an airplane landing time approaches and thus the first electronic device receives airplane mode off contents and then an airplane mode is turned off, the second electronic device may be also in the airplane off mode. In contrast, when the second electronic device receives the airplane mode on/off contents and thus the airplane mode of the second electronic device is turned on/off, the airplane mode of the first electronic device may be turned on/off.

According to various embodiments of the present disclosure, the third application may automatically activate function information configured in the contents based on the attribute of the third application or the state of the electronic device in which the third application is configured. For example, when shopping mall contents are received, if it is determined that the electronic device is located in a shopping mall related to the shopping mall contents, the third application may automatically activate a related shopping mall application. Alternatively, for example, when vehicle check contents are received, the third application may automatically activate a Wi-Fi function of the electronic device to connect communication of the vehicle through Wi-Fi or activate a BT function of the electronic device to connect communication of the vehicle through BT.

A method of providing information by an electronic device according to various embodiments of the present disclosure may include an operation of receiving contents from a second application by using a first application being executed in the electronic device, and an operation of providing at least some of the contents in a first format through an output device functionally connected to the electronic device when a state of the electronic device or an attribute of the first application corresponds to a first state or a first attribute, and an operation of providing the at least some of the contents in a second format through the output device when the state of the electronic device or the attribute of the first application corresponds to a second state or a second attribute. The second application may include an application executed in the electronic device. The second application may include an application executed in an external device of the electronic device. The operation of receiving contents may include an operation of receiving function information related to the contents. The method may include an operation of performing at least one function, which is related to the contents and provided by the electronic device or the external device of the electronic device based on the function information. The operation of performing the at least one function may include an operation of automatically performing the at least one function based on the state of the electronic device or the attribute of the first application.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing information by an electronic device, the method comprising:
receiving, by a first application executed in the electronic device, a plurality of contents including first contents and second contents from at least one second application; and
generating third contents, which are different from at least some of one of the first contents and the second contents based on at least one of the first contents and the second contents, by the first application.

2. The method of claim 1, wherein the receiving of the plurality of contents comprises receiving function information corresponding to at least some of one of the first contents and at least some of the second contents.

3. The method of claim 1,
wherein the generating of the third contents comprises generating function information corresponding to at least some of the third contents, and
wherein the function information comprises information for activating a function provided by at least one of a third application receiving the third contents, the electronic device, and an external device of the electronic device.

4. The method of claim 1, further comprising transmitting at least some of the third contents to a third application.

5. The method of claim 4, wherein the transmitting of the at least some of the third contents comprises:
when at least one of an attribute of the third application and a state of the electronic device executing the third application correspond to at least one of a first attribute and a first state, transmitting at least some contents of the third application; and
when the at least one of an attribute of the third application and a state of the electronic device executing the third application correspond to at least one of a second attribute and a second state, refraining from transmitting at least some contents of the third application.

6. The method of claim 5, wherein at least one of the first application, the second application, and the third application comprises at least one of a Short Message Service (SMS)/Multimedia Messaging Service (MMS) application, an email application, a calendar application, an alarm application, and a healthcare application.

7. A method of providing information by an electronic device, the method comprising:
receiving contents from a second application by using a first application executed in an electronic device;
when at least one of a state of the electronic device and an attribute of the first application corresponds to at least one of a first state and a first attribute, providing at least some of the contents with a first format through an output device functionally connected to the electronic device; and
when at least one of a state of the electronic device and an attribute of the first application corresponds to at least one of a second state and a second attribute, providing at least some of the contents with a second format through the output device.

8. The method of claim 7, wherein the second application comprises an application executed in the electronic device.

9. The method of claim 7, wherein the second application comprises an application executed in an external device of the electronic device.

10. The method of claim 9, wherein the receiving of the contents comprises receiving function information related to the contents.

11. The method of claim 10, further comprising performing at least one function provided by at least one of the electronic device related to the contents and the external device of the electronic device.

12. The method of claim 11, wherein the performing of the at least one function comprises automatically performing the at least one function based on the at least one of the state of the electronic device and the attribute of the first application.

13. The method of claim 7, wherein each of the first application and the second application comprises at least one of a Short Message Service (SMS)/Multimedia Messaging Service (MMS) application, an email application, a calendar application, an alarm application, and a healthcare application.

14. An electronic device comprising:
a first application configured:
to receive a plurality of contents including first contents and second contents from at least one second application, and
to generate third contents that are different from at least some of one of the first contents and the second contents based on at least one of the first contents and the second contents.

15. The electronic device of claim 14, wherein the first application is further configured to receive function information corresponding to at least some of one of the first contents and at least some of the second contents.

16. The electronic device of claim 14,
wherein the first application is further configured to generate function information corresponding to at least some of the third contents, and
wherein the function information comprises information for activating a function provided by at least one of the third application receiving the third contents, the electronic device, and an external device of the electronic device.

17. The electronic device of claim 14, wherein the first application is further configured to transmit at least some of the third contents to a third application.

18. The electronic device of claim 17, wherein the first application is further configured:
to transmit at least some contents of the third application when an attribute of the third application and a state of the electronic device executing the third application correspond to at least one of a first attribute and a first state, and
to refrain from transmitting at least some contents of the third application when the at least one of an attribute of the third application and a state of the electronic device executing the third application correspond to one of a second attribute and a second state.

19. The electronic device of claim 14, wherein at least one of the first application, the second application, and the third application comprises at least one of a Short Message Service (SMS)/Multimedia Messaging Service (MMS) application, an email application, a calendar application, an alarm application, and a healthcare application.

20. An electronic device comprising:
a first application configured:
to receive contents from a second application, to provide at least some of the contents with a first format through an output device functionally connected to the electronic device when at least one of a state of the electronic device and an attribute of the first application corresponds to at least one of a first state and a first attribute, and
to provide the at least some of the contents with a second format through the output device when the at least one of the state of the electronic device and the attribute of the first application corresponds to at least one of a second state and a second attribute.

21. The electronic device of claim 20, wherein the second application comprises an application executed in the electronic device.

22. The electronic device of claim 20, wherein the second application comprises an application executed in an external device of the electronic device.

23. The electronic device of claim 22, wherein the first application is further configured to receive function information related to the contents.

24. The electronic device of claim 23, wherein the first application is further configured to perform at least one function provided by at least one of the electronic device related to the contents and the external device of the electronic device.

25. The electronic device of claim 24, wherein the first application is further configured to automatically perform the at least one function based on at least one of the state of the electronic device and the attribute of the first application.

26. The electronic device of claim 20, wherein each of the first application and the second application comprises at least one of a Short Message Service (SMS)/Multimedia Messaging Service (MMS) application, an email application, a calendar application, an alarm application, and a healthcare application.

27. A non-transitory computer-readable storage medium for storing a computer program of instructions configured to be readable by at least one processor for instructing the at least one processor to execute a computer process for performing the method of claim 1.
